(19) United States
(12) Patent Application Publication
(10) Pub. No.: US 2024/0172176 A1
(43) Pub. Date: May 23, 2024

(54) MANAGING DOWNLINK EARLY DATA TRANSMISSION

(71) Applicant: GOOGLE LLC, Mountain View, CA (US)

(72) Inventor: Chih-Hsiang Wu, Taoyuan City (TW)

(21) Appl. No.: 18/283,786

(22) PCT Filed: Mar. 23, 2022
(86) PCT No.: PCT/US22/21517

§ 371 Date: Sep. 22, 2023

Related U.S. Application Data
(60) Provisional application No. 63/165,374, filed on Mar. 24, 2021.

(51) Int. Cl. H04W 68/00; H04W 68/02

(52) U.S. Cl. CPC H04W 68/005; H04W 68/02

(57) ABSTRACT

A central unit (CU) of distributed base station can implement a method for managing downlink early data transmission to a user equipment (UE) when the UE operates in an inactive state associated with a protocol for controlling radio resources. The method includes: determining (1602) to communicate data to the UE without transitioning the UE to a connected state associated with the protocol; and, in response to the determining, transmitting (1604), to a distributed unit (DU) of the distributed base station, an indication that the UE is to initiate a procedure for receiving the data without transitioning to the connected state.

### FIELD OF THE DISCLOSURE

This disclosure relates generally to wireless communications and, more particularly, to communication of uplink and/or downlink data at a user equipment (UE) when the UE operates in an inactive or idle state associated with a protocol for controlling radio resources.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Generally speaking, a base station operating a cellular radio access network (RAN) communicates with a user equipment (UE) using a certain radio access technology (RAT) and multiple layers of a protocol stack. For example, the physical layer (PHY) of a RAT provides transport channels to the Medium Access Control (MAC) sublayer, which in turn provides logical channels to the Radio Link Control (RLC) sublayer, and the RLC sublayer in turn provides data transfer services to the Packet Data Convergence Protocol (PDCP) sublayer. The Radio Resource Control (RRC) sublayer is disposed above the PDCP sublayer.

The RRC sublayer specifies the RRC_IDLE state, in which a UE does not have an active radio connection with a base station; the RRC_CONNECTED state, in which the UE has an active radio connection with the base station; and the RRC_INACTIVE to allow a UE to more quickly transition back to the RRC_CONNECTED state due to Radio Access Network (RAN)-level base station coordination and RAN-paging procedures. In some cases, the UE in the RRC_IDLE or RRC_INACTIVE state has only one, relatively small packet to transmit. In these cases, the UE is in the RRC_IDLE or RRC_INACTIVE state can perform an early data transmission without transitioning to the RRC_CONNECTED state, e.g., by using techniques as specified in section 7.3 in 3GPP specification 36.300 v16.4.0.

However, implementing early data transmission techniques presents several challenges. For example, existing downlink early data transmission procedures were developed for LTE networks, which do not utilize the distributed base station architecture introduced for 5G New Radio (NR). Accordingly, it is not clear how a distributed base station including a central unit (CU) and a distributed unit (DU) should support downlink early data communication with a UE.

### SUMMARY

Network nodes of a RAN can use the techniques of this disclosure to manage downlink early data transmission (EDT). A CU of a distributed base station can determine that downlink data is available for a UE while the UE operates in the inactive state. The CU can then determine whether (i) to cause the UE to transition to the connected state in order to receive the data, or (ii) to initiate EDT in order to communicate the data with the UE without transitioning the UE to the connected state.

If the CU determines to initiate EDT, then the CU sends a CU-to-DU message to the DU of the distributed base station. In the CU-to-DU message, the CU includes an EDT indication that indicates that the UE is to receive the data without transitioning to the connected state. In some implementations, the EDT indication is interpretable by the DU. In response to receiving the EDT indication, the DU generates a paging message for the UE including a second EDT indication that is interpretable by the UE. The DU can then transmit this paging message to the UE, which causes the UE to initiate an EDT procedure (e.g., by sending an UL RRC message to the DU including an EDT indication). In other implementations, the CU generates a paging message including an EDT indication that is interpretable by the UE. The DU forwards this CU-generated paging message to the UE.

The CU can determine to initiate EDT based on different factors, depending on the implementation. For example, the CU can determine to initiate EDT based on a volume of the data to be transferred, a data size indication, or an explicit indication from another node (e.g., a second base station) or a core network (CN).

Further, the CU may include two logical nodes: a control plane node (i.e., a CU-CP) and a user plane node (i.e., a CU-UP). In some implementations, the user plane node determines to initiate EDT. In such implementations, the user plane node can transmit a notification message to the control plane node indicating that downlink data is available for the UE and that the downlink data is to be communicated to the UE without transitioning the UE to the connected state. In other implementations, the control plane node can determine to initiate EDT. For example, the control plane node can receive an indication of the data size from the user plane node and determine to initiate EDT based on the data size. As another example, if the control plane node receives the downlink data (e.g., from the CN), the control plane node can determine, independently from the user plane node, to initiate EDT. The control plane node, or the user plane node, may receive a message indicating that downlink data is available for the UE and/or the downlink data itself, from another node, the core network, or another base station, to make the determination whether to initiate EDT.

One example embodiment of these techniques is a method implemented in a CU of a distributed base station for managing downlink EDT to a UE when the UE operates in an inactive state associated with a protocol for controlling radio resources. The method can be executed by processing hardware and includes: determining to communicate data to the UE without transitioning the UE to a connected state associated with the protocol; and, in response to the determining, transmitting, to a DU of the distributed base station, an indication that the UE is to initiate a procedure for receiving the data without transitioning to the connected state.

Another example embodiment of these techniques is a method implemented in a DU of a distributed base station for managing downlink EDT to a UE when the UE operates in an inactive state associated with a protocol for controlling radio resources. The method can be executed by processing hardware and includes: receiving, from a CU of the distributed base station, a first indication that the UE is to initiate a procedure for receiving data without transitioning to a connected state associated with the protocol; and, in response to the first indication, generating a paging message including a second indication that the UE is to initiate the procedure.

A further example embodiment of these techniques is a network node of a distributed base station including processing hardware and configured to implement any one of the methods above.

### BRIEF DESCRIPTION OF THE DRAWINGS

FIG. 1A is a block diagram of an example wireless communication system in which a user device and a base station of this disclosure can implement the techniques of this disclosure for managing downlink early data transmission (EDT);

FIG. 1B is a block diagram of an example base station including a central unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3A is an example message sequence in which a CU determines to initiate EDT and sends an EDT indication to a DU, which causes the DU to generate a paging message for a UE indicating that the UE is to initiate EDT;

FIG. 3B is an example message sequence similar to the message sequence of FIG. 3A, but where the CU generates the paging message for the UE indicating that the UE is to initiate EDT;

FIG. 4A is an example message sequence similar to the message sequences of FIGS. 3A-3B, but where a CU-UP, a user plane node of the CU, determines to initiate EDT and transmits an EDT indication to a CU-CP, a control plane node of the CU;

FIG. 4B is an example message sequence similar to the message sequences of FIGS. 3A-3B, but where a CU-CP determines to initiate EDT based on a data size received from the CU-UP;

FIG. 4C is an example message sequence similar to the message sequences of FIGS. 3A-3B, but where a CU-CP determines to initiate EDT based on a downlink data packet that the CU-CP receives for the UE;

FIG. 4D is an example message sequence similar to the message sequences of FIGS. 3A-3B, but where a CU-CP determines to initiate EDT based on a message that the CU-CP receives (e.g., from a core network (CN) or from another base station);

FIG. 5A is an example message sequence in which a CN determines to initiate EDT and transmits a message including an EDT indication to the CU;

FIG. 5B is an example message sequence in which a second base station determines to initiate EDT and transmits a message including an EDT indication to the CU;

FIG. 6 is a flow diagram of an example method for transmitting a paging message to a UE that includes an EDT indication, which can be implemented by a DU;

FIG. 7 is a flow diagram of an example method for transmitting a paging message to multiple UEs including an EDT indication, which can be implemented by a DU;

FIG. 8 is a flow diagram of an example method for determining whether to include an EDT indication in a paging message for a UE, which can be implemented by a DU;

FIG. 9 is a flow diagram of an example method for transmitting a CU-to-DU message to a DU that includes an EDT indication, which can be implemented by a CU;

FIG. 10 is a flow diagram of an example method for transmitting a CU-to-DU message to a DU that includes an EDT indication for multiple UEs, which can be implemented by a CU;

FIG. 11A is a flow diagram of an example method for determining whether to include an EDT indication in a CU-to-DU message, which can be implemented by a CU;

FIG. 11B is a flow diagram of an example method similar to the method of FIG. 11A, but where the CU determines whether to include the EDT indication based on a volume of data to be transmitted to the UE;

FIG. 11C is a flow diagram of an example method similar to the method of FIG. 11A, but where the CU determines whether to include the EDT indication based on whether a message that the CU receives indicates to use EDT;

FIG. 11D is a flow diagram of an example method similar to the method of FIG. 11A, but where the CU determines whether to include the EDT indication based on a size of data to be transmitted to the UE;

FIG. 12 is a flow diagram of an example method for transmitting an UP-to-CP message that includes an EDT indication, which can be implemented by a CU-UP;

FIG. 13A is a flow diagram of an example method for determining whether to include an EDT indication in an UP-to-CP message, which can be implemented by a CU-UP;

FIG. 13B is a flow diagram of an example method similar to the method of FIG. 13A, but where the CU-UP determines whether to include the EDT indication based on a volume of data to be transmitted to the UE;

FIG. 14A is a flow diagram of an example method for determining whether to transmit data for the UE to the CU-CP, which can be implemented by a CU-UP;

FIG. 14B is a flow diagram of an example method similar to the method of FIG. 14A, but where the UE determines whether to transmit the data to the CU-CP based on a volume of the data, which can be implemented by a CU-UP;

FIG. 15A is a flow diagram of an example method for determining whether to include an EDT indication in an UP-to-CP message based on whether a message that the CU-UP receives indicates to use EDT, which can be implemented by a CU-UP;

FIG. 15B is a flow diagram of an example method similar to the method of FIG. 15A, but where the CU-UP determines whether to include the EDT indication based on a size of data to be transmitted to the UE;

FIG. 16 is a flow diagram of an example method for managing downlink EDT, which can be implemented by a CU; and

FIG. 17 is a flow diagram of an example method for managing downlink EDT, which can be implemented by a DU.

### DETAILED DESCRIPTION OF THE DRAWINGS

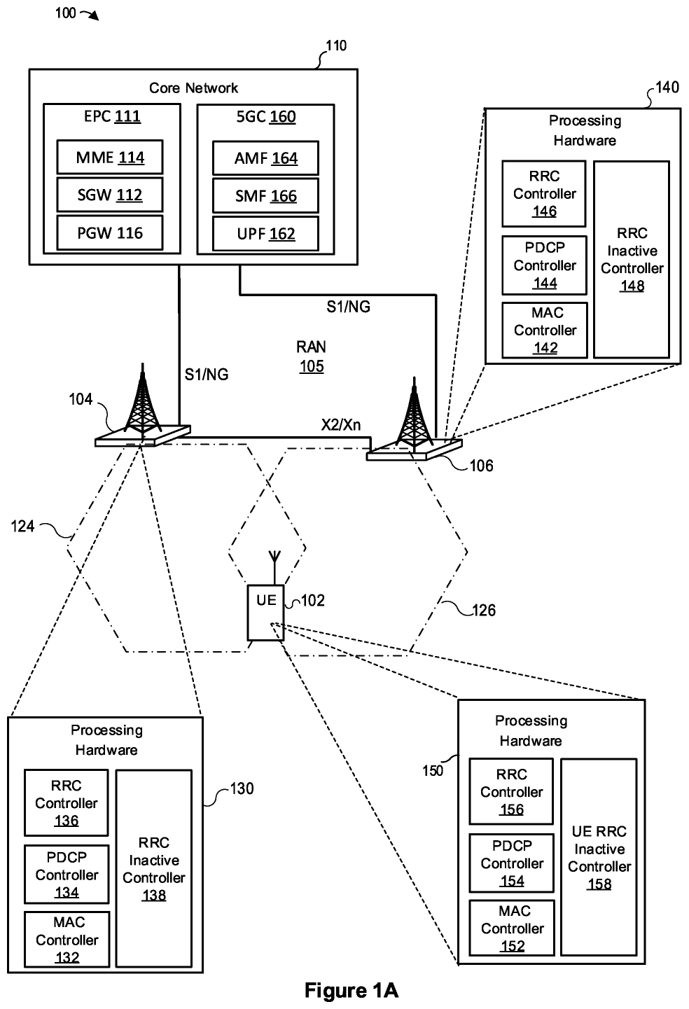

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core, in another example.

The base station 104 covers a cell 124, and the base station 106 covers a cell 126. If the base station 104 is a gNB, the cell 124 is an NR cell. If the base station 124 is an ng-eNB, the cell 124 is an evolved universal terrestrial radio access (E-UTRA) cell. Similarly, if the base station 106 is a gNB, the cell 126 is an NR cell, and if the base station 126 is an ng-eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NW”) or E-UTRA air interface to communicate with the base stations 104 and 106. Each of the base stations 104, 160 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 implement the techniques of this disclosure to communicate data when the radio connection between the UE 102 and the RAN 105 is suspended, e.g., in the inactive or idle state of the protocol for controlling radio resources between the UE 102 and the RAN 105. For clarity, the examples below refer to the RRC_INACTIVE or RRC_IDLE state of the RRC protocol.

As used in this disclosure, the term “data” or “data packet” refers to signaling, control-plane information at a protocol layer of controlling radio resources (e.g., RRC), controlling mobility management (MM), controlling session management (SM), or refers to non-signaling, non-control-plane information at protocol layers above the layer of the protocol for controlling radio resources (e.g., RRC), above the layer of the protocol for controlling MM, above the layer of the protocol for controlling SM, or above the layer of the protocol for controlling quality of service (QoS) flows (e.g., service data adaptation protocol (SDAP)). The data to which the UE and/or the RAN applies the techniques of this disclosure can include, for example, Internet of things (IoT) data, Ethernet traffic data, Internet traffic data, or a short message service (SMS) message. Further, as discussed below, the UE 102 in some implementations applies these techniques only if the size of the data is below a certain threshold value.

In the example scenarios discussed below, the UE 102 transitions to the RRC_INACTIVE or RRC_IDLE state, then selects a cell of the base station 104, and exchanges data with the base station 104, either via the base station 106 or with the base station 104 directly, without transitioning to the RRC_CONNECTED state. In particular, the UE 102 and the base station 104 of the RAN 105 can communicate using early data transmission procedures, without the UE 102 transitioning to the RRC_CONNECTED state.

As a more specific example, the UE 102 in some cases transmits data in the uplink (UL) direction to the RAN 105 while the UE 102 operates in the RRC_INACTIVE or RRC_IDLE state.

After the UE 102 determines that data is available for uplink transmission while the UE 102 operates in the RRC_INACTIVE or RRC_IDLE state, the UE 102 can apply one or more security functions to the UL data packet, generate a first UL protocol data unit (PDU) including the security-protected packet, include a UL RRC message along with the first UL PDU in a second UL PDU, and transmit the second UL PDU to the RAN 105. The UE 102 includes a UE identity/identifier (ID) of the UE 102 in the UL RRC message. The RAN 105 can identify the UE 102 based on the UE ID. In some implementations, the UE ID can be an inactive Radio Network Temporary Identifier (I-RNTI), resume identity, or a non-access stratum (NAS) ID. The NAS ID can be an S-Temporary Mobile Subscriber Identity (S-TMSI) or a Global Unique Temporary Identifier (GUTI).

The security function can include an integrity protection and/or encryption function. When integrity protection is enabled, the UE 102 can generate a message authentication code for integrity (MAC-I) to protect integrity of the data. Thus, the UE 102 in this case generates a security-protected packet including the data and the MAC-I. When encryption is enabled, the UE 102 can encrypt the data to obtain an encrypted packet, so that the security-protected packet includes encrypted data. When both integrity protection and encryption are enabled, the UE 102 can generate a MAC-I for protecting integrity of the data and encrypt the data along with the MAC-I to generate an encrypted packet and an encrypted MAC-I. The UE 102 then can transmit the security-protected packet to the RAN 105, while in the RRC_INACTIVE or RRC_IDLE state.

In some implementations, the data is an uplink (UL) service data unit (SDU) of the packet data convergence protocol (PDCP) or SDAP. The UE 102 applies the security function to the SDU and includes the secured SDU in a first UL PDU (e.g., a UL PDCP PDU). The UE 102 then includes the UL PDCP PDU in a second UL PDU, such as a UL MAC PDU, which can be associated with the medium access control (MAC) layer. Thus, the UE 102 in these cases transmits the secured UL PDCP PDU in the UL MAC PDU. In some implementations, the UE 102 can include, in the UL MAC PDU, a UL RRC message. In other implementations, the UE 102 may omit a UL RRC message from the UL MAC PDU. In such implementations, the UE 102 may omit a UE ID of the UE 102 from the UL MAC PDU. In yet other implementations, the UE 102 can include the UL PDCP PDU in a UL radio link control (RLC) PDU and then include the UL RLC PDU in the UL MAC PDU. In the case of including the UL RRC message in the UL MAC PDU, the UE 102 in some implementations generates an RRC MAC-I and includes the RRC MAC-I in the UL RRC message. For example, the RRC MAC-I is a resumeMAC-I field, as specified in 3GPP specification 38.331. In other implementations, the UE can obtain the RRC MAC-I from the UL RRC message with an integrity key (e.g., K_{RRcint} key), an integrity protection algorithm, and other parameters COUNT (e.g., 32-bit, 64-bit or 128-bit value), BEARER (e.g., 5-bit value), and DIRECTION (e.g., 1-bit value).

In other implementations, the data is an uplink (UL) protocol data unit (SDU) of the NAS. The UE 102 applies the security function to the SDU and includes the secured SDU in a first UL PDU such as a NAS PDU, which can be associated with the NAS layer. For example, the NAS layer can be an MM sublayer or an SM sublayer of 5G, Evolved Packet System (EPS), or 6G. Then the UE 102 can include the UL NAS PDU in a second UL PDU, such as a UL RRC message. Thus, the UE 102 in these cases transmits the (first) secured UL NAS PDU in the UL RRC message. In some implementations, the UE 102 can include the UL RRC message in a UL MAC PDU and transmits the UL MAC PDU to a base station (e.g., base station 104 or 106) via a cell (e.g., cell 124 or 126). In this case, the UE 102 may omit an RRC MAC-I from the UL RRC message. Alternatively, the UE 102 may include an RRC MAC-I as described above.

In some implementations, the UL RRC message described above can be a common control channel (CCCH) message, an RRC resume request message, or an RRC early data request message. The UL RRC message can include a UE ID of the UE 102 as described above.

More generally, the UE 102 can secure the data using at least one of encryption and integrity protection, include the secured data as a security-protected packet in the first UL PDU, and transmit the first UL PDU to the RAN 105 in the second UL PDU.

In some scenarios and implementations, the base station 106 can retrieve the UE ID of the UE 102 from the UL RRC message and identify the base station 104 as the destination of the data in the first UL PDU, based on the determined UE ID. In one example implementation, the base station 106 retrieves the first UL PDU from the second UL PDU and transmits the first UL PDU to the base station 104. The base station 104 then retrieves the security-protected packet from the first UL PDU, applies one or two security functions to decrypt the data and/or check the integrity protection, and transmits the data to the CN 110 (e.g., SGW 112, UPF 162, MME 114 or AMF 164) or an edge server. In some implementations, the edge server can operate within the RAN 105. More specifically, the base station 104 derives at least one security key from UE context information of the UE 102. Then the base station 104 retrieves the data from the security-protected packet by using the at least one security key and transmits the data to the CN 110 or edge server. When the security-protected packet is an encrypted packet, the base station 104 decrypts the encrypted packet to obtain the data by using the at least one security key (e.g., an (d)encryption key). If the security-protected packet is an integrity-protected packet, the integrity protected packet may include the data and the MAC-I. The base station 104 can verify whether the MAC-I is valid for the security-protected packet by using the at least one security key (e.g., an integrity key). When the base station 104 confirms that the MAC-I is valid, the base station 104 sends the data to the CN 110 or edge server. On the other hand, when the base station 104 determines that the MAC-I is invalid, the base station 104 discards the security-protected packet. Further, if the security-protected packet is both encrypted and integrity-protected, the encrypted and integrity-protected packet may include the encrypted packet along with the encrypted MAC-I. The base station 104 in this case decrypts the encrypted packet and the encrypted MAC-I to obtain the data and the MAC-I. The base station 104 then determines whether the MAC-I is valid for the data. If the base station 104 determines that the MAC-I is valid, the base station 104 retrieves the data and forwards the data to the CN 110 or edge server. However, if the base station 104 determines that the MAC-I is invalid, the base station 104 discards the packet.

In another implementation, the base station 106 retrieves the security-protected packet from the first UL PDU. The base station 106 performs a retrieve UE context procedure with the base station 104 to obtain UE context information of the UE 102 from the base station 104. The base station 106 derives at least one security key from the UE context information. Then the base station 106 retrieves the data from the security-protected packet by using the at least one security key and transmits the data to the CN 110 (e.g., UPF 162) or an edge server. When the security-protected packet is an encrypted packet, the base station 106 decrypts the encrypted packet to obtain the data by using the at least one security key (e.g., an (d)encryption key). If the security-protected packet is an integrity-protected packet, the integrity protected packet may include the data and the MAC-I. The base station 106 can verify whether the MAC-I is valid for the security-protected packet by using the at least one security key (e.g., an integrity key). When the base station 106 confirms that the MAC-I is valid, the base station 106 sends the data to the CN 110. On the other hand, when the base station 106 determines that the MAC-I is invalid, the base station 106 discards the security-protected packet. Further, if the security-protected packet is both encrypted and integrity-protected, the encrypted and integrity-protected packet may include the encrypted packet along with the encrypted MAC-I. The base station 106 in this case decrypts the encrypted packet and the encrypted MAC-I to obtain the data and the MAC-I. The base station 106 then determines whether the MAC-I is valid for the data. If the base station 106 determines that the MAC-I is valid, the base station 106 retrieves the data and forwards the data to the data CN 110. However, if the base station 106 determines that the MAC-I is invalid, the base station 106 discards the packet.

In other scenarios and implementations, the base station 104 can retrieve the UE ID of the UE 102 from the UL RRC message and identify that the base station 104 stores UE context information of the UE 102. Thus, the base station 104 retrieves the security-protected packet from the first UL PDU, retrieve the data from the security-protected packet and sends the data to the CN 110 or edge server as described above.

Further, the RAN 105 in some cases transmits data in the downlink (DL) direction to the UE 102 operating in the RRC_INACTIVE or RRC_IDLE state.

For example, when the base station 104 determines that data is available for downlink transmission to the UE 102 that is currently operating in the RRC_INACTIVE or RRC_IDLE state, the base station 104 can apply at least one security function to the data to generate a security-protected packet, generate a first DL PDU including the security-protected packet, and include the first DL PDU in a second DL PDU. To secure the data, the base station 104 can apply the security function (e.g., integrity protection and/or encryption) to the data. More particularly, when integrity protection is enabled, the base station 104 generates a MAC-I for protecting integrity of the data, so that the security-protected packet includes the data and the MAC-I. When encryption is enabled, the base station 104 encrypts the data to generate an encrypted packet, so that the security-protected packet is an encrypted packet. Further, when both integrity protection and encryption are enabled, the base station 104 can generate a MAC-I for protecting integrity of the data and encrypt the data along with the MAC-I to generate an encrypted packet and an encrypted MAC-I. The base station 104 in some implementations generates a first DL PDU, such as a DL PDCP PDU including the security-protected packet, and then includes the first DL PDU in a second DL PDU associated with the MAC layer, for example (e.g., a DL MAC PDU), and transmits the second DL PDU to the UE 102 without first causing the UE 102 to transition from the RRC_INACTIVE or RRC_IDLE state to the RRC_CONNECTED state. In some implementations, the base station 104 includes the DL PDCP PDU in a DL RLC PDU, then includes the DL RLC PDU in the DL MAC PDU, and then transmits the DL MAC PDU to the UE 102 without first causing the UE 102 to transition from the RRC_INACTIVE or RRC_IDLE state to the RRC_CONNECTED state.

In another implementation, the base station 104 transmits the first DL PDU to the base station 106, which then generates a second PDU (e.g., a DL MAC PDU) including the first DL PDU and transmits the second DL PDU to the UE 102 without first causing the UE 102 to transition from the RRC_INACTIVE or RRC_IDLE state to the RRC_CONNECTED state. In some implementations, the base station 106 generates a DL RLC PDU including the first DL PDU and includes the DL RLC PDU in the second DL PDU. In yet another implementation, the base station 104 includes the first DL PDU in a DL RLC PDU and transmits the DL RLC PDU to the base station 106, which then generates a second DL PDU (e.g., a DL MAC PDU) including the DL RLC PDU and transmits the second DL PDU to the UE 102.

In some implementations, the base station (i.e., the base station 104 or 106) generates a downlink control information (DCI) and a cyclic redundancy check (CRC) scrambled with an ID of the UE 102 to transmit the second DL PDU generated by the base station. In some implementations, the ID of the UE 102 can be a Radio Network Temporary Identifier (RNTI). For example, the RNTI can be a cell RNTI (C-RNTI), a temporary C-RNTI, or an inactive C-RNTI. The base station transmits the DCI and scrambled CRC on a physical downlink control channel (PDCCH) to the UE 102 operating in the RRC_INACTIVE or RRC_IDLE state. The base station scrambles the CRC with the ID of the UE 102. In some implementations, the base station may assign the ID of the UE 102 to the UE 102 in a random access response that the base station transmits in a random access procedure with the UE 102 before transmitting the DCI and scrambled CRC. In other implementations, the base station may assign the ID of the UE 102 to the UE 102 in an RRC message (e.g., an RRC release message or an RRC reconfiguration message) that the base station transmits to the UE 102 before transmitting the DCI and scrambled CRC, e.g., while the UE 102 was previously operating in the RRC_CONNECTED state, RRC_INACTIVE state, or RRC_IDLE state.

The UE 102 operating in the RRC_INACTIVE or RRC_IDLE state can receive the DCI and scrambled CRC on the PDCCH. Then the UE 102 confirms that a physical downlink shared channel (PDSCH), including the second DL PDU, is addressed to the UE according to the ID of the UE 102, DCI, and scrambled CRC. The UE 102 then can retrieve the data from the security-protected packet. If the security-protected packet is an encrypted packet, the UE 102 can decrypt the encrypted packet using the appropriate decryption function and the security key to obtain the data. If the security-protected packet is the integrity-protected packet including the data and the MAC-I, the UE 102 can determine whether the MAC-I is valid. If the UE 102 confirms that the MAC-I is valid, the UE 102 retrieves the data. If, however, the UE 102 determines that the MAC-I is invalid, the UE 102 discards the packet. Finally, when the security-protected packet is both encrypted and integrity-protected, with encrypted data and an encrypted MAC-I, the UE 102 can decrypt the encrypted packet and encrypted MAC-I to obtain the data and the MAC-I. The UE 102 then can verify that the MAC-I is valid for the data. If the UE 102 confirms that the MAC-I is valid, the UE 102 retrieves and processes the data. Otherwise, when the UE 102 determines that the MAC-I is invalid, the UE 102 discards the data.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a Medium Access Control (MAC) controller 132 configured to perform a random access procedure with one or more user devices, receive uplink MAC protocol data units (PDUs) from one or more user devices, and transmit downlink MAC PDUs to one or more user devices. The processing hardware 130 can also include a Packet Data Convergence Protocol (PDCP) controller 134 configured to transmit DL PDCP PDUs in accordance with which the base station 104 can transmit data in the downlink direction, in some scenarios, and receive UL PDCP PDUs in accordance with which the base station 104 can receive data in the uplink direction, in other scenarios. The processing hardware further can include an RRC controller 136 to implement procedures and messaging at the RRC sublayer of the protocol communication stack. The processing hardware 130 in an example implementation includes an RRC inactive controller 138 configured to manage uplink and/or downlink communications with one or more UEs operating in the RRC_INACTIVE or RRC_IDLE state. The base station 106 can include generally similar components. In particular, components 140, 142, 144, 146, and 148 can be similar to the components 130, 132, 134, 136, and 138, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes an RRC inactive controller 158 configured to manage uplink and/or downlink communications when the UE 102 operates in the RRC_INACTIVE state. The processing hardware 150 in an example implementation includes a Medium Access Control (MAC) controller 152 configured to perform a random access procedure with a base station, transmit uplink MAC protocol data units (PDUs) to the base station, and receive downlink MAC PDUs from the base station. The processing hardware 150 can also include a PDCP controller 154 configured to transmit DL PDCP PDUs in accordance with which the base station 106 can transmit data in the downlink direction, in some scenarios, and receive UL PDCP PDUs in accordance with which the base station 106 can receive data in the uplink direction, in other scenarios. The processing hardware further can include an RRC controller 156 to implement procedures and messaging at the RRC sublayer of the protocol communication stack.

FIG. 1B depicts an example, distributed or disaggregated implementation of any one or more of the base stations 104, 106. In this implementation, the base station 104, 106 includes a central unit (CU) 172 and one or more DUs 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller such as PDCP controller 134, 144, RRC controller 136, 146 and/or RRC inactive controller 138, 148. In some implementations, the CU 172 can include a radio link control (RLC) controller configured to manage or control one or more RLC operations or procedures. In other implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or a RLC controller configured to manage or control one or more RLC operations or procedures. The process hardware can also include a physical layer controller configured to manage or control one or more physical layer operations or procedures.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C or W1-C interface. The CU-UP 172B can be connected to one or more DU 174 through an F1-U or W1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

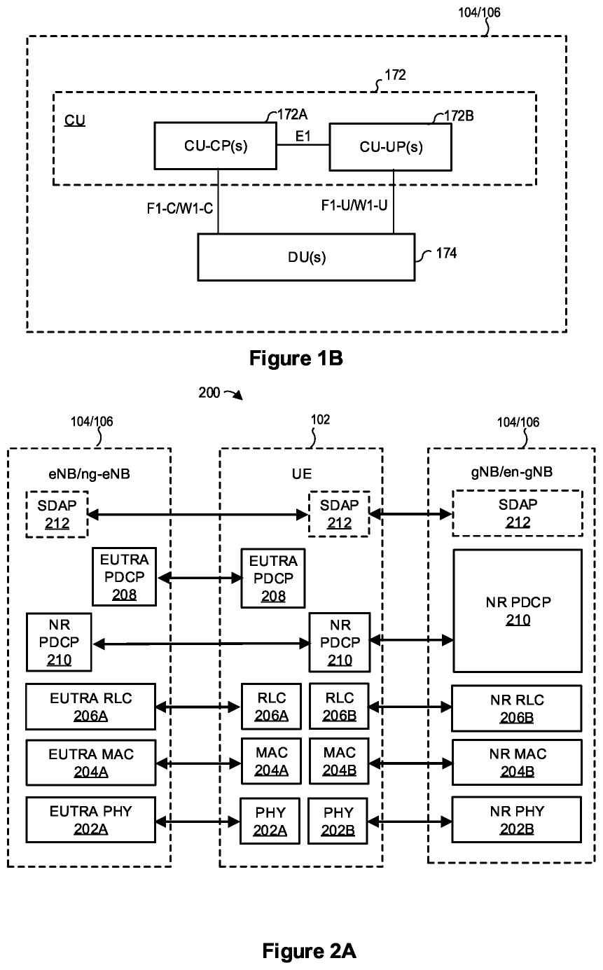

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide signaling radio bearers (SRBs) or RRC sublayer (not shown in FIG. 2A) to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250 which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

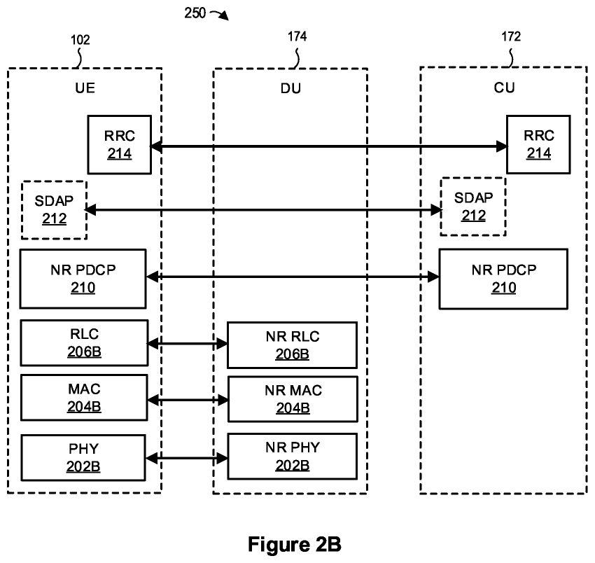

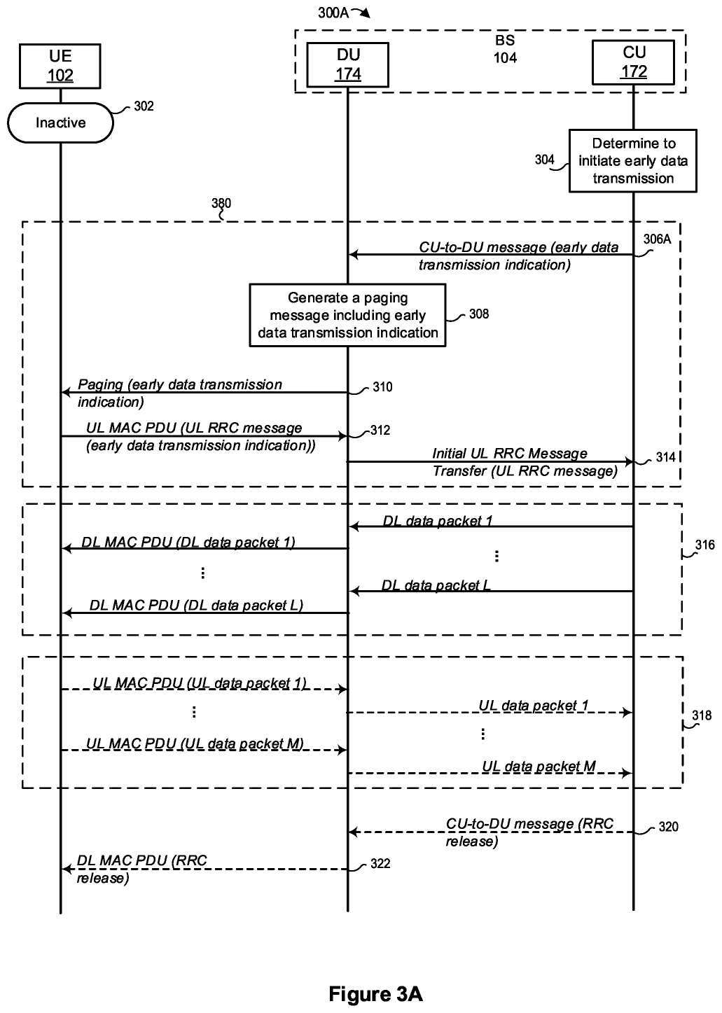

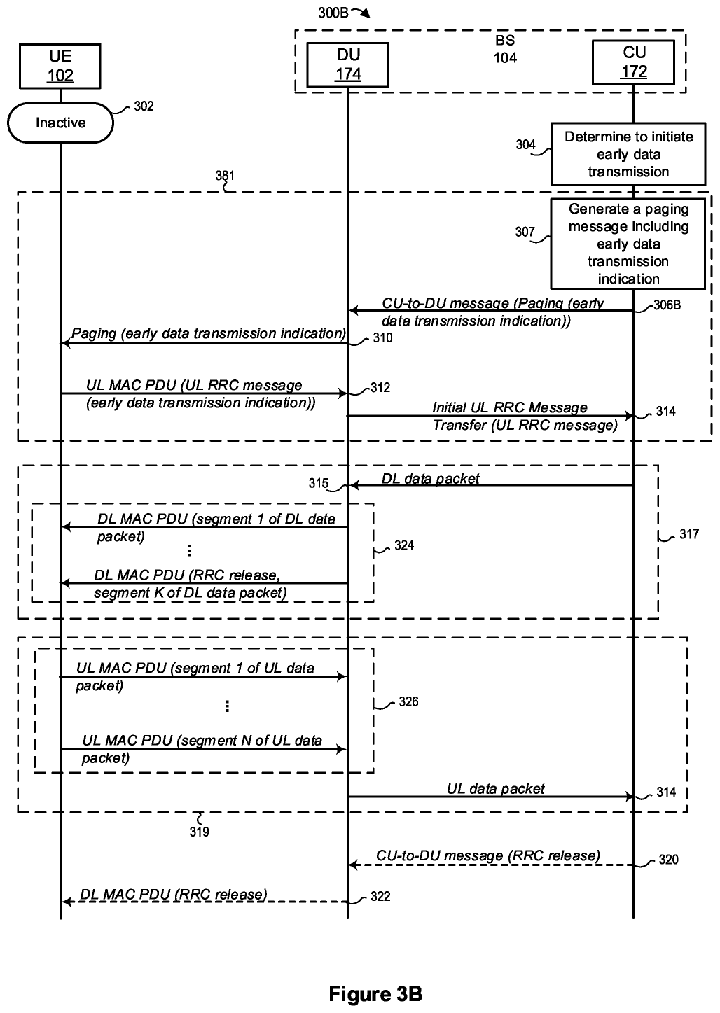

FIGS. 3A-3B, 4A-4D, and 5A-5B are messaging diagrams of example scenarios in which a UE and nodes of a RAN implement the techniques of this disclosure for downlink early data transmission. Generally speaking, events in FIGS. 3A-3B, 4A-4D, and 5A-5B that are similar are labeled with similar reference numbers (e.g., event 302 in FIG. 3A is similar to event 302 in FIG. 3B, events 402 in FIGS. 4A-4D, and 502 in FIGS. 5A-5B), with differences discussed below where appropriate. With the exception of the differences shown in the figures and discussed below, any of the alternative implementations discussed with respect to a particular event (e.g., for messaging and processing) may apply to events labeled with similar reference numbers in other figures.

Referring first to FIG. 3A, in a scenario 300A, the UE 102 initially operates 302 in an inactive state (e.g., RRC_INACTIVE or RRC_IDLE) and the base station 104 includes a CU 172 and a DU 174. In some scenarios and implementations, the UE 102 previously operated in a connected state with the RAN 105 (e.g., with the base station 104, base station 106, or another base station not shown in FIG. 1A), before transitioning to the inactive state. After a (first) certain period of data inactivity for the UE 102, the RAN 105 can determine that neither the RAN 105 nor the UE 102 has transmitted any data in the downlink direction or the uplink direction, respectively, during the (first) certain period. In response to the determination, the RAN 105 can transmit a first RRC release message (e.g., RRCRelease message or RRCConnectionRelease message) to the UE 102 and instruct the UE 102 to transition to the inactive state. The UE 102 transitions to the inactive state upon receiving the first RRC release message and operates 302 in the inactive state. The RAN 105 can assign UE identity/identifier (ID) (e.g., an I-RNTI or a resume ID) to the UE 102 and include the assigned value in the first RRC release message. After the UE 102 transitions to the inactive state, the UE 102 may perform one or more RAN notification area (RNA) updates with the CU 172 via the DU 174 without state transitions, in some cases. In some implementations, the CU 172 can include a security parameter (e.g., Next Hop Chaining Count) in the first RRC release message. The UE 102 derives security keys (i.e., base key, integrity key(s) and/or encryption key(s)) using the security parameter. For example, the UE 102 derives a base key (e.g., K_{gNB}) using the security parameter and derives integrity key(s) (e.g., K_{RRCint} key and/or the K_{UPint} key) and encryption key(s) (e.g., K_{RRCenc} key and/or K_{UPenc} key) from the base key. The CU 172 derives security keys (i.e., same as the security keys derived by the UE 102) in a similar manner as the UE 102. The UE 102 can include the UE ID in the UL RRC message that the UE 102 transmits 302. The UE 102 and CU 172 use the integrity key (e.g., the K_{UPint} key) and/or encryption key (e.g., the K_{UPenc} key) in data communication in events 316, 318 and 320. The UE 102 and CU 172 use the integrity key (e.g., the K_{RRCint} key) and/or encryption key (e.g., the K_{RRcenc} key) in communication of the first RRC release message in events 320 and 322.

At a later time, while the UE 102 operates 302 in the inactive state, the CU 172 determines 304 to initiate early data transmission (EDT) to transmit downlink (DL) data to the UE 102. The DL data in some example scenarios is an Internet Protocol (IP) packet, an Ethernet packet, or an application packet. In other scenarios, the DL data is a PDU (e.g., RRC PDU, PDCP PDU, RLC PDU, or MAC PDU) that includes an RRC message, a NAS message, an IP packet, an Ethernet packet, or an application packet. Still further, the DL data in some scenarios can be an RRC PDU including a NAS PDU, such that the NAD PDU includes an IP packet, an Ethernet packet, or an application packet. In response to the determination, the CU 172 generates a CU-to-DU message (e.g., F1 AP Paging message or W1AP Paging message) including a first EDT indication and sends 306A the CU-to-DU message to the DU 174. In some implementations, the CU 172 includes a UE ID of the UE 102 in the CU-to-DU message. For example, the UE ID is the I-RNTI or resume ID. In another example, the UE ID is a NAS ID (e.g., S-TMSI or GUTI). The first EDT indication may be an information element (IE), field, or flag of the CU-to-DU message addressed to the DU. The first EDT indication notifies the DU 174 that the CU 172 has data available for the UE 102 that the UE 102 is to receive using EDT (i.e., without transitioning to the connected state).

In response to the first EDT indication, the DU 174 generates 308 a paging message addressed to the UE that includes a second EDT indication. The second EDT indication may be an IE, field, or flag generated by the DU and may be different than the first EDT indication. The second EDT indication instructs the UE 102 to initiate EDT in order to receive DL data.

Generally speaking, this disclosure refers to an “EDT indication” as an indication that the UE is to initiate, or is requesting to initiate, EDT in order to exchange data with the RAN 105 without transitioning to the connected state. An EDT indication may be formatted in accordance with a suitable protocol, depending on the transmitter of the EDT indication (e.g., a node of the RAN 105 or the UE 102) and the recipient or addressee of the EDT indication. For example, in the scenario 300A, the first EDT indication that the CU 172 transmits 306A is included as an element of a CU-to-DU message addressed to the DU 174. The first EDT indication may be formatted in accordance with a protocol having termination points at the CU 172 and the DU 174 (e.g., the F1 application protocol (FLAP) or W1 application protocol (W1AP)). The second EDT indication that the DU 174 transmits 310 is included as an element of a paging message addressed to the UE 102 and may be formatted in accordance with a protocol having termination points at the UE 102 and the DU 174. As discussed below with reference to event 312, the UE 102 may transmit an EDT indication to the CU 172 via the DU 174 to indicate that the UE 102 is requesting to initiate EDT, where the EDT indication may be formatted in accordance with a protocol having termination points at the UE 102 at the CU 172.

In some implementations, the paging message that the DU 174 generates 308 can be an RRC Paging message or a MAC control element or a physical layer signaling. In response to or after receiving 306A the CU-to-DU message, the DU 174 transmits 310 the paging message to the UE 102. For example, the physical layer signaling can be a downlink control information (DCI) with a CRC scrambled with an RNTI (e.g., paging RNTI) and the DU 174 can send the DCI and the scrambled CRC on a physical downlink control channel (PDCCH). In another example, the DU 174 may transmit 310 the paging message on a shared channel (e.g., a Physical Downlink Shared Channel (PDSCH)). In response to the paging message, the UE 102 operating in the inactive state transmits 312 to the DU 174 an uplink (UL) MAC PDU including an UL RRC message. In such cases, the UE 102 may omit UL data from the UL MAC PDU. Examples of the UL data are similar to the DL data. After receiving 312 the UL MAC PDU, the DU 174 extracts the UL RRC message from the UL MAC PDU and sends 314 to the CU 172 an Initial UL RRC Message Transfer message including the UL RRC message. Receiving 314 the UL RRC message notifies the CU 172 that the UE 102 has initiated or is requesting to initiate EDT. The events 306A, 308, 310, 312, and 314 are collectively referred to in FIG. 3A as a DL EDT initiation procedure 380.

In some implementations, the UL RRC message can be an RRC resume request message (e.g., RRCResumeRequest message or RRCConnectionResumeRequest message). In such cases, the UE 102 can include an EDT indication in the UL RRC message in response to the second early data indication in the paging message. The EDT indication in the message the UE 102 transmits 312 indicates to the RAN 105 that the UE 102 is initiating EDT, instead of, for example, a legacy RRC resume procedure in which the UE 102 transitions to a connected state. Such an EDT indication can be a new field in the RRC resume request message or a resume cause value. For example, the resume cause value can be specific for mobile terminating EDT. In another example, the resume cause value can be used for both mobile originating EDT and mobile terminating EDT.

In other implementations, the UL RRC message can be specific for EDT. For example, the UL RRC message can be an RRCEarlyDataRequest message or a new RRC message. In such cases, the UE 102 may omit an EDT indication from the UL RRC message. The RAN 105 can determine, based on the type of message rather than an EDT indication, that the UE 102 is initiating EDT. In some implementations, the UE 102 includes a cause value for mobile terminating access in the UL RRC message.

In some implementations, the CU 172 can perform a UE Context procedure (e.g., UE Context Setup procedure or UE Context Modification procedure) with the DU 174 to setup or modify a UE context in response to or after receiving the Initial UL RRC Message Transfer message. In the UE Context procedure, the CU 172 can send a UE Context Request message to the DU 174 and the DU 174 can send a UE Context Response message in response. The CU 172 may or may not include an EDT indication in the UE Context Request message. In one implementation, the UE Context Request message and UE Context Response message can be a UE Context Setup Request message and a UE Context Setup Response message, respectively. In another implementation, the UE Context Request message and UE Context Response message can be a UE Context Modification Request message and a UE Context Modification Response message, respectively.

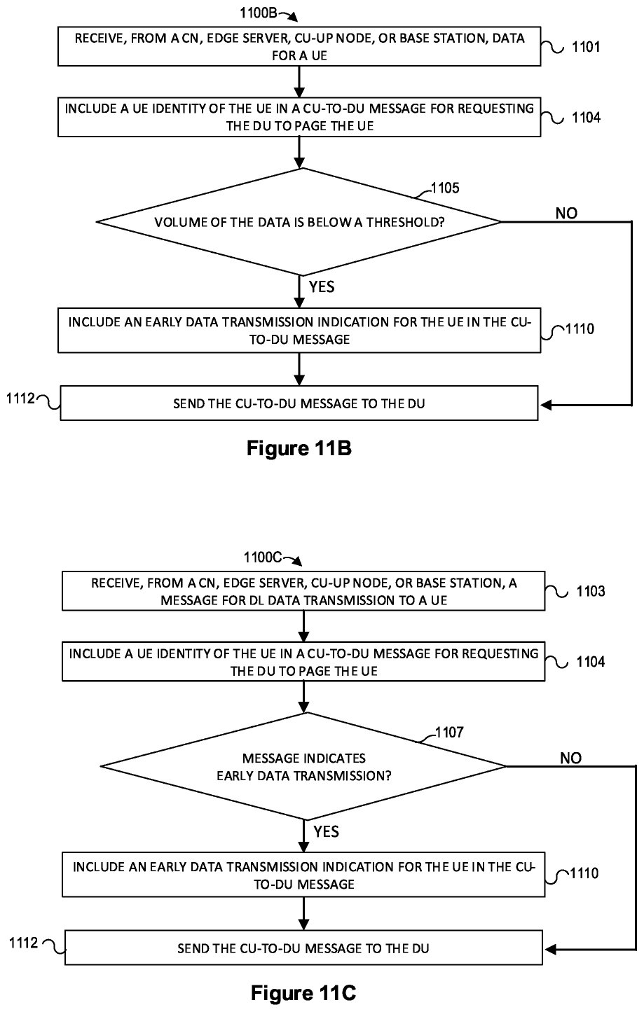

In some implementations, the CU 172 can determine whether the data qualifies for transmission in the inactive state in view of one or more of such factors as whether the data is an IMS packet, whether the data is associated with a radio bearer (e.g., DRB or SRB), S1 bearer, a evolved radio access bearer (E-RAB), or quality of service (QoS) flow not suitable or configured for early data transmission, whether the data is an NAS message for initiating a particular NAS procedure, the size of the data, etc. Some of these factors will be further described in FIGS. 11A-11D and 13A-15B. When the CU 172 determines that the data does not qualify for transmission in the inactive state, the CU 172 determines to initiate non-early data transmission to the UE 102 instead of the early data transmission. If the CU 172 determines to initiate non-EDT to the UE 102 instead of the EDT, the CU 172 can generate a second CU-to-DU message, include the UE ID in the second CU-to-DU message (e.g., F1AP Paging message or W1AP Paging message) and exclude an EDT indication from the second CU-to-DU message. In response to the second CU-to-DU message excluding an EDT indication, the DU 174 can send a second paging message including the UE ID to the UE 102. In response to or after receiving the second paging message, the UE 102 can perform an RRC procedure (e.g., RRC connection establishment procedure or RRC resume procedure) with the CU 172 via the DU 174 to transition to the connected state.

After receiving 314 the Initial UL RRC Message Transfer message or the UL RRC message, the CU 172 can transmit 316 at least one downlink (DL) data packet for the UE 102 to the DU 174. The CU 172 can receive a DL data packet from the CN 110 or the edge server. In turn, the DU 174 can generate at least one DL MAC PDU including the at least one DL data packet and send 316 the at least one DL MAC PDU to the UE 102 operating in the inactive state. A DL MAC PDU in the at least one DL MAC PDU can include a particular DL data packet of the at least one DL data packet or include a segment of the particular DL data packet. In some implementations, the at least one DL data packet includes L DL data packets, where L is a positive integer, and may be less than a predetermined value. In some implementations, the DU 174 sends 316, to the UE 102, L DL MAC PDUs, where each includes a particular DL data packet of the at least one DL data packets. In other implementations, the DU 174 can send to the UE 102 plural DL MAC PDUs each including a segment of a particular DL data packet, as described below with reference to event 324 in FIG. 3B. In yet other implementations, the DU 174 can send to the UE 102 a DL MAC PDU including at least two DL data packets of the L data packets.

In some implementations, the UE 102 operating in the inactive state can send 318 at least one UL data packets to the CU 172 via the DU 174, after receiving some or all of the at least one DL MAC PDU. Specifically, the UE 102 generates at least one UL MAC PDU including the at least one UL data packet and send 318 the at least one UL MAC PDU to the DU 174. A UL MAC PDU in the at least one UL MAC PDU can include a particular UL data packet of the at least UL data packet or include a segment of the particular UL data packet. In some implementations, the at least one UL data packet includes M UL data packets, where M is an integer and greater than 0, and may be less than a predetermined value. In some implementations, the UE 102 sends 318 to the DU 174 M UL MAC PDUs, where each includes a particular UL data packet of the at least one UL data packets. In other implementations, the UE 102 can send to the DU 174 plural UL MAC PDUs each including a segment of a particular UL data packet, as described below with reference to event 326 in FIG. 3B. In yet other implementations, the UE 102 can send to the DU 174 a UL MAC PDU including at least two UL data packets of the M data packets.

After transmitting 316 the at least DL data packet and/or receiving 318 the at least one UL data packet, the CU 172 can determine to stop the EDT. In response to the determination, the CU 172 can transmit 320 a CU-to-DU message including a second RRC Release message to the DU 174, which in turn transmits 322 a DL MAC PDU including the second RRC release message to the UE 102. When the UE 102 receives 322 the second RRC release message, the UE 102 determines the EDT (session) ends and remains in the inactive state. In response to or after receiving the second RRC release message, the UE 102 stops attempting to receive a DL MAC PDU which includes a DL data packet and/or stops transmitting a UL MAC PDU which includes a UL data packet. In some implementations, the CU 172 can include a new UE ID (e.g., I-RNTI or resume identity) and/or a security parameter (e.g., Next Hop Chaining Count) in the second RRC release message. The UE 102 derives security keys (i.e., base key, integrity key(s) and/or encryption key(s)) using the security parameter. For example, the UE 102 derives a base key (e.g., K_{gNB}) using the security parameter and derives integrity key(s) (e.g., K_{RRcint} key and/or the K_{UPint} key) and encryption key(s) (e.g., K_{RRcenc} key and/or K_{UPenc} key) from the base key. The UE 102 uses the new UE ID, integrity key(s) and/or encryption key(s) in a subsequent EDT (e.g., mobile originating EDT or mobile terminating EDT like FIG. 3A), as described above.

Depending on the implementation, the CU 172 may or may not include a DL data packet in the CU-to-DU message that the CU 172 transmits 320. In one implementation, if the CU 172 does include a DL data packet in the CU-to-DU message, the DU 174 can include the DL data packet in the DL MAC PDU that the DU 174 transmits 322. In another implementation, the DU 174 can generate at least one additional DL MAC PDU (e.g., Y DL MAC PDUs, where Y is a positive integer) including (some or all of segments of) the DL data packet and transmits the at least one additional DL MAC PDU to the UE 102. In this implementation, the DU 174 may or may not include a segment of the DL data packet in the DL MAC PDU that the DU 174 transmits 322. The DU 174 transmits the at least one additional DL MAC PDU before the DU 174 transmits 322 the DL MAC PDU including the second RRC release message. In some implementations, the DU 174 may transmit 322 the DL MAC PDU after receiving hybrid automatic repeat request (HARQ) acknowledgement(s) for the additional DL MAC PDU.

In some implementations, the DU 174 transmits at least one DCI with a cyclic redundancy check (CRC) scrambled with a specific RNTI on PDCCH(s), to transmit 316 the DL MAC PDU(s) and/or 322 the DL MAC PDU, and/or to schedule the UE 102 to transmit 318 the UL MAC PDU(s). In response to or after receiving the second RRC release message, the UE 102 stops attempting to monitor or receive the specific RNTI on PDCCH(s). The specific RNTI can be a C-RNTI, EDT C-RNTI, EDT-RNTI, preconfigured uplink resources (PUR)-RNTI, PUR C-RNTI, configured grant (CG)-RNTI, CG C-RNTI, preconfigured grant (PCG)-RNTI, or PCG C-RNTI.

In some implementations, the CU-to-DU message the CU 172 transmits 320 can be a UE Context Release Command message. In response, the DU 174 can send to the CU 172 a UE Context Release Complete message. In other implementations, the CU-to-DU message the CU transmits 320 can be a DL RRC Message Transfer message or a UE Context Modification Request message. The DU 174 can send to the CU 172 a UE Context Modification Response message in response to the UE Context Modification Response message. In such cases, the CU 172 can send to the DU 174 another UE Context Release Command message for the UE 102 after sending 320 the CU-to-DU interface message to the DU 174. In response, the DU 174 can send to the CU 172 another UE Context Release Complete message. In yet other implementations, the CU-to-DU message that the CU 172 transmits 320 can be a new or existing F1AP message or W1AP message specified in 3GPP specification 38.473 or 37.473.

In some implementations, the UE 102 in the inactive state can perform a random access procedure with the DU 174 in response to receiving 310 the paging message or to transmit 312 the UL RRC message. For example, the random access procedure can be a four-step random access procedure or a two-step random access procedure. In the case of the four-step random access procedure, the UE 102 transmits a random access preamble to the base station 104 and in response, the base station 104 transmits to the UE 102 a random access response (RAR) including an uplink grant, and the UE 102 transmits 312 the UL MAC PDU in accordance with the uplink grant. The DU 174 receives 312 the UL MAC PDU in accordance with the uplink grant in the RAR. In the case of the two-step random access procedure, the UE 102 transmits 312 to the DU 174 a message A including a random access preamble and the UL MAC PDU in accordance with two-step random access configuration parameters. The UE 102 receives the two-step random access configuration parameters in system information broadcast by the DU 174 on cell 124 before transmitting 312 the UL MAC PDU. The DU 174 receives 312 the message A or the UL MAC PDU in accordance with the two-step random access configuration parameters. In other implementations, the UE 102 can transmit 312 the UL MAC PDU on radio resources configured in a PUR configuration or a CG configuration for EDT. The CU 172 can include the PUR or CG configuration for the UE 102 in the first RRC release message. Thus, the base station 104 receives 312 the UL MAC PDU on the radio resources in accordance with the PUR or CG configuration.

In some implementations, the RRC release message that the CU 172 transmits 320 can be an RRCConnectionRelease message or an RRCRelease message.

Turning to FIG. 3B, a scenario 300B is generally similar to the scenario 300A, except that the CU 172 generates the paging message. In particular, after determining 304 to initiate EDT to transmit DL data to the UE 102, the CU 172 generates 307 a paging message including an EDT indication. The EDT indication that the CU 172 includes in the paging message is similar to the second EDT indication that the DU 174 generates 308 in the scenario 300A. The paging message is addressed to the UE 102 and thus the EDT indication may be formatted in accordance with a protocol having termination points at the CU 172 and the UE 102. The CU 172 transmits 306B the paging message including the EDT indication to the DU 174 in a CU-to-DU message. The DU 174 extracts the paging message from the CU-to-DU message and transmits 310 the paging message including the EDT indication to the UE 102. The events 306B, 307, 310, 312, and 314 are collectively referred to in FIG. 3B as a DL EDT initiation procedure 381.

After receiving 314 the Initial UL RRC Message Transfer message or the UL RRC message, the CU 172 can transmit 315 a DL data packet to the DU 174. The DU 174 then determines to segment the DL data packet (e.g., because a DL MAC PDU cannot accommodate the whole DL data packet). Accordingly, the DU 174 divides the DL data packet into segments and transmit 324 a first data segment (i.e., segment 1) of the DL data packet to the UE 102 in a first DL MAC PDU. After transmitting the first data segment, the DU 174 can transmit 324 to the UE 102 subsequent DL MAC PDU(s) (e.g., K-1 DL MAC PDU(s), wherein K is a natural number and larger than 1), where each subsequent DL MAC PDU includes a segment of the DL data packet. After receiving 324 the K segments of the DL data packet, the UE 102 assembles the K segments to obtain the DL data packet. The events 315 and 324 are collectively referred to as a DL EDT procedure 317.

Likewise, the UE 102 can determine to segment an UL data packet (e.g., because a UL MAC PDU cannot accommodate the whole UL data packet). The UE 102 can transmit 326 a first data segment of the UL data packet to the DU 174 in a first UL MAC PDU. After transmitting the first data segment, the UE 102 can transmit 326 to the DU 174 subsequent UL MAC PDU(s) (e.g., N-1 UL MAC PDU(s), wherein Nis a natural number and larger than 1), where each subsequent UL MAC PDU includes a segment of the UL data packet. After receiving 326 the N segments of the UL data packet, the DU 174 assembles the N segments to obtain the UL data packet. The DU 174 can then transmit 314 the UL data packet to the CU 172. The events 314 and 326 are collectively referred to as a UL EDT procedure 319.

While FIG. 3B illustrates the DL EDT procedure 317, in other implementations, the CU 172 can transmit 316 DL data packet(s) to the DU 174 and the DU 174 may refrain from segmenting the data, as in the scenario 300A. Similarly, while FIG. 3B illustrates the UL EDT procedure 319, in other implementations, the UE 102 can transmit 318 UL data packet(s) to the DU 174 without segmenting the data, as in the scenario 300A.

FIGS. 4A-4D illustrate scenarios that may be similar to the scenarios 300A and 300B. However, FIGS. 4A-4D illustrate specific actions that may be performed by the control plane node (i.e., the CU-CP) and the user plane node (i.e., the CU-UP) of the CU. In particular, depending on the scenario, either the CU-CP or the CU-UP may determine to initiate EDT.

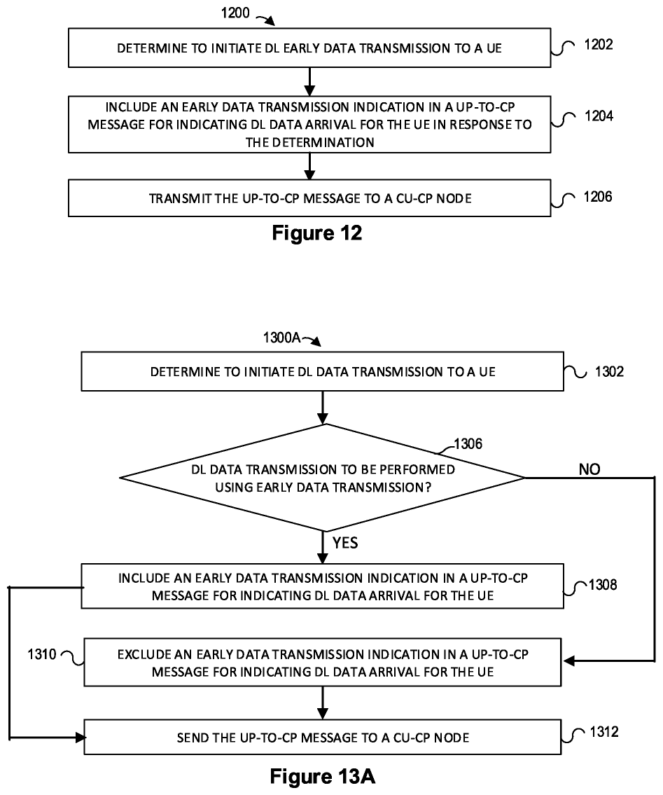

Turning first to FIG. 4A, in a scenario 400A, a base station 104 includes a DU 174, a CU-CP 172A, and a CU-UP 172B, where the CU-CP 172A and the CU-UP 172B are nodes of the CU 172. While the UE 102 operates 402 in an inactive state, the CU-UP 172B determines 404 to initiate EDT to transmit DL data to the UE 102. In some implementations, the CU-UP 172B may determine 404 to initiate EDT based on a size of the DL data to transmit to the UE 102. In other implementations, the CU-UP 172B may determine 404 to initiate EDT based on an ID of a radio bearer, an S1 bearer, an E-RAB or a QoS (flow) with which the DL data is associated. Some of the factors that the CU-UP 172B can use to determine whether to initiate EDT will be further described in FIGS. 13A-15B. The CU-UP 172B can then transmit 432 a DL data notification message including an EDT indication to the CU-CP 172A. The DL data notification message indicates that DL data is available for transmission to the UE 102, and the EDT indication notifies the CU-CP 172A that the DL data is to be transmitted to the UE 102 using EDT (i.e., without causing the UE 102 to transition to the connected state).

After receiving 432 the DL data notification message, the CU-CP 172A performs a DL EDT initiation procedure 480 with the DU 174 and the UE 102. The DL EDT initiation procedure 480 may be similar to the DL EDT initiation procedure 380 or the DL EDT initiation procedure 381. Accordingly, to initiate the DL EDT initiation procedure 480, the CU-CP 172A can either transmit a CU-to-DU message including an EDT indication to the DU 174, similar to the event 306A, or generate a paging message including an EDT indication and transmit the paging message in a CU-to-DU message to the DU 174, similar to the event 306B.

After the DL early data transmission initiation procedure 480, the CU-CP 172A transmits 434 a CP-to-UP message to the CU-UP 172B to notify the CU-UP 172B that the UE 102 is connected to the CU-CP 172A or to request the CU-UP 172B to setup or modify a bearer context of the UE 102. The CU-UP 172B then transmits 416 at least one DL data packet to the UE 102 via the DU 174, similar to event 316. In some implementations, after receiving the DL data packet from the CU-UP 172B, the DU 174 may segment the DL data packet and transmit the segments in separate DL MAC PDUs, similar to event 317. If the UE 102 has UL data to transmit to the base station 104, the UE 102 can transmit 418 the UL data to the CU-UP 172B via the DU 174, similar to event 318. In some implementations, to transmit 418 an UL data packet to the DU 174, the UE 102 segments the UL data packet and transmit the segments to the DU 174, which the DU 174 can assemble before transmitting the UL data packet to the CU-UP 172B, similar to event 319. In some implementations, the CP-to-UP message can be a Bearer Context Modification Request message. The CU-UP 172B may send a Bearer Context Modification Response message in response to the Bearer Context Modification Request message. In other implementations, the CP-to-UP message can be a Bearer Context Setup Request message. The CU-UP 172B may send a Bearer Context Setup Response message in response to the Bearer Context Modification Request message.

If there is no additional DL data or UL data to communicate with the UE 102, the CU-UP 172B can transmit 436 an UP-to-CP message to the CU-CP 172A. The CU-CP 172A then transmits 420 a CU-to-DU message including an RRC release message to the DU 174, which in turn transmits 422 a DL MAC PDU including the RRC release message to the UE 102, similar to the events 320 and 322.

Turning to FIG. 4B, a scenario 400B is generally similar to the scenario 400A, except that the CU-CP 172A determines whether to initiate EDT. In particular, the CU-UP 172B transmits 422 a DL data notification message to the CU-CP 172A indicating that DL data is available for the UE 102. Based on the DL data notification message, the CU-CP 172A determines 405 to initiate EDT. For example, the DL data notification message includes an indication of the size of the DL data (e.g., DL data size information), and the CU-CP 172A can determine 405 to initiate EDT based on the size. The CU-CP 172A may compare the size to a threshold (e.g., a threshold for EDT that is preconfigured at the CU-CP 172A or received at the CU-CP 172A from the CN 110) and, if the size is below the threshold, determine 405 to initiate EDT rather than a procedure that causes the UE 102 to transition to the connected state. The remaining events of the scenario 400B may be similar to similarly-numbered events in the scenario 400A. In some implementations, the CU-UP 172B can include an ID of a radio bearer, S1 bearer, E-RAB or QoS (flow) with which the DL data is associated in the DL data notification message. The CU-CP 172A can determine whether to initiate EDT in accordance with the identity. In such cases, the CU-CP 172A may or may not include the data size info.

Turning to FIG. 4C, a scenario 400C is generally similar to the scenario 400B, except that the CU-CP 172A determines to initiate EDT without considering information received from the CU-UP 172B. The CU-CP 172A receives 403C a DL data packet for the UE 102. As an example, the CN 110 may transmit the DL data packet directly to the CU-CP 172A. As another example, the CN 110 may transmit a NAS message including the DL data packet to the CU-CP 172A. The CN 110A may transmit the DL data packet to the CU-CP 172A rather than the CU-UP 172B because the UE 102 is operating 402 in the inactive state. As yet another example, the CU-UP 172B may transmit the DL data to the CU-CP 172A. Based on the DL data packet (e.g., a size or a volume of the DL data to be transmitted to the UE 102 or an ID of a radio bearer, S1 bearer, E-RAB or QoS (flow) with which the DL data is associated), the CU-CP 172 determines 405 to initiate EDT.

The CU-CP 172A can then initiate a DL EDT initiation procedure 480. After receiving an Initial UL RRC Message Transfer message or an UL RRC message during the DL EDT initiation procedure 480, the CU-CP 172A transmits 446 the DL data packet that the CU-CP 172A received 403C to the UE 102 via the DU 174. The CU-CP 172A also may receive 448 an UL data packet from the UE 102 via the DU 174. The events 446 and 448 are similar to the events 416 and 418, respectively, except that the CU-CP 172A, rather than the CU-UP 172B, exchanges the data with the UE 102.

If there is no additional DL data or UL data to communicate with the UE 102, the CU-CP 172A transmits 420 a CU-to-DU message including an RRC release message to the DU 174, which in turn transmits 422 a DL MAC PDU including the RRC release message to the UE 102, similar to the events 320 and 322.

Turning to FIG. 4D, a scenario 400D is generally similar to the scenario 400B, except that the CU-CP 172A determines to initiate EDT based on a message received from a different source than the CU-UP 172B. The CU-CP 172A receives 403D a message indicating that DL data is available for the UE 102. Based on the message, the CU-CP 172A determines 405 to initiate EDT. The message may be a CN-to-BS message from the CN 110 or a BS-to-BS message from another base station (e.g., the base station 106), for example. As will be described below with reference to FIGS. 5A-5B, in some implementations the message includes an indication that the CU-CP 172A is to initiate EDT for the UE 102. In other implementations, the CU-CP 172A determines to initiate EDT based on information included in the message (e.g., a data size indication or a volume of the data or an ID of a radio bearer, S1 bearer, E-RAB, or QoS (flow)). The remaining events of the scenario 400D may be similar to similarly-numbered events in the scenario 400A.

Referring next to FIG. 5A, in a scenario 500A, a base station 104 includes a CU 172 and a DU 174 and is in communication with a CN 110. The CN 110 determines 554 to initiate EDT. In response, the CN 110 transmits 556 a CN-to-BS message including an EDT indication to the CU 172. The CN 110 also transmits 558 one or more DL data packet(s) to the CU 172. The CN-to-BS message that the CN 110 transmits 556 may be the message that the CU-CP 172A receives 403D during the scenario 400D. The CN 110 may transmit 558 the DL data packet(s) to the CU-UP 172B (e.g., as in the scenarios 400A, 400B, and 400D, in which the CU-UP 172B transmits the DL data packets to the UE 102 via the DU 174) or to the CU-CP 172A (e.g., as in the scenario 400C, in which the CU-CP 172A transmits the DL data packets to the UE 102 via the DU 174).

Event 580 may be similar to any one of events 380, 381, or 480. Event 516 may be similar to any one of events 316, 317, 416, or 446. Event 518 may be similar to any one of events 318, 319, 418, or 448. After receiving 518 UL data packet(s) from the UE 102, the CU 172 can transmit 560 the UL data packet(s) to the CN 110. If there is no additional DL data or UL data to communicate with the UE 102, the CU 172 transmits 520 a CU-to-DU message including an RRC release message to the DU 174, which in turn transmits 522 a DL MAC PDU including the RRC release message to the UE 102, similar to the events 320 and 322.

Turning to FIG. 5B, the scenario 500B is similar to the scenario 500A, except that a base station 106 rather than the CN 110 determines to initiate EDT. In particular, the base station 106 determines 564 to initiate EDT and, in response, transmits 566 a BS-to-BS message including an EDT indication to the CU 172. The base station 106 may be a base station that was previously connected to the UE 102 (e.g., when the UE 102 was operating in the connected state prior to transitioning to the inactive state). Thus, the base station 106 may store the UE context for the UE 102. The BS-to-BS message that the base station 106 transmits 566 may be the message that the CU-CP 172A receives 403D during the scenario 400D. The base station 106 may also transmit 568 DL data packet(s) for the UE 102 to the CU 172, which the CU 172 in turn transmits 516 to the UE 102. Likewise, the CU 172 may transmit 570 UL data packet(s) that the CU 172 receives 518 from the UE 102 to the base station 106.

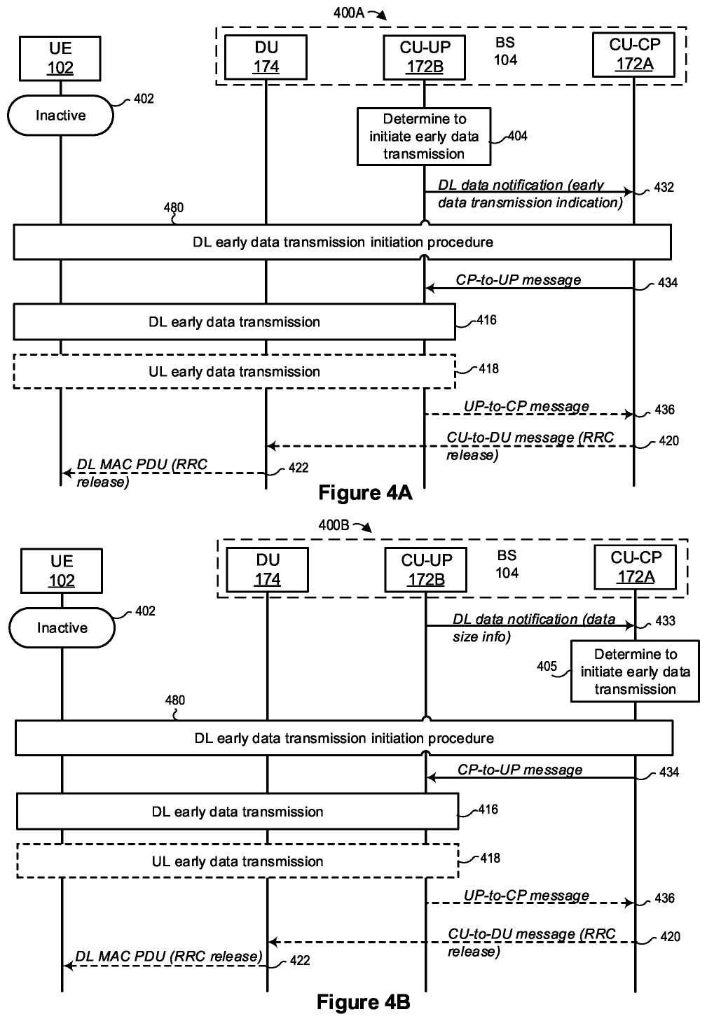

FIGS. 6-17 are flow diagrams depicting example methods that nodes of a RAN (e.g., the RAN 105) can perform for managing DL EDT to a UE (e.g., the UE 102).

FIG. 6 is a flow diagram of an example method 600 for transmitting a paging message to a UE (e.g., the UE 102) that includes an EDT indication, which can be implemented by a DU (e.g., the DU 174). At block 602, the DU receives, from a CU (e.g., the CU 172), a CU-to-DU message including a first EDT indication for a UE (e.g., events 306A, 480, 580). The first EDT indication notifies the DU that there is data available for the UE and that the UE is to receive the data from the CU using EDT. Accordingly, in response to the first EDT indication, at block 604, the DU includes a second EDT indication in a paging message for the UE 102 (e.g., event 308, 480, 580). The DU then transmits the paging message to the UE at block 606 (e.g., event 310, 480, 580). The second EDT indication causes the UE to initiate EDT to receive the data.

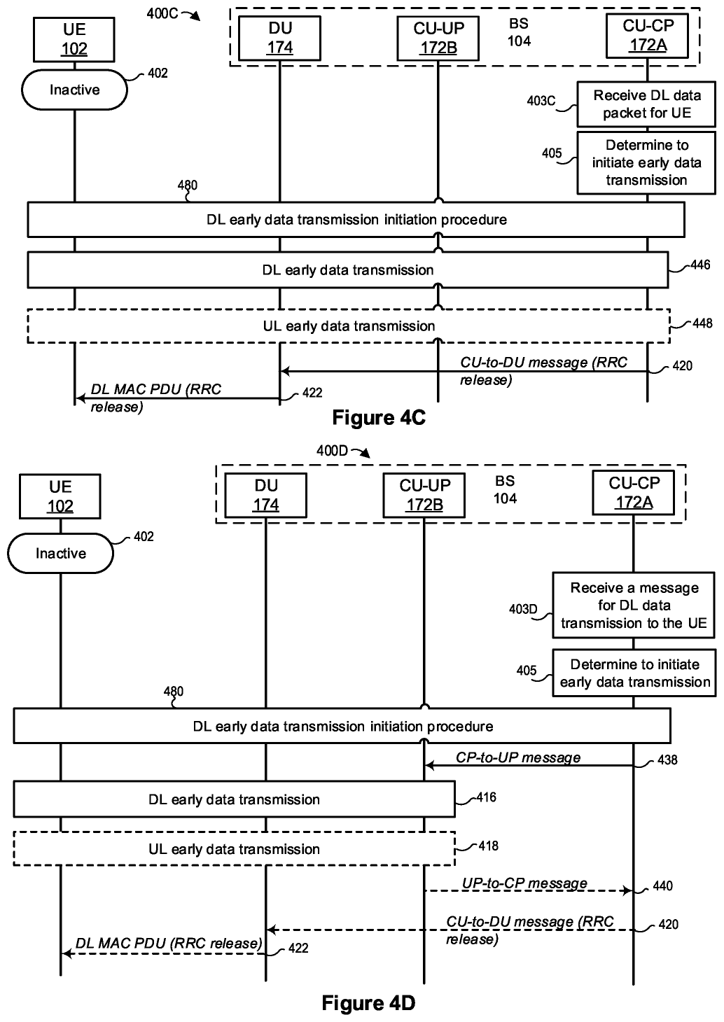

FIG. 7 is a flow diagram of an example method 700 for transmitting a paging message to multiple UEs (e.g., multiple UEs including the UE 102) including an EDT indication, which can be implemented by a DU (e.g., the DU 174). At block 702, the DU receives, from a CU (e.g., the CU 172), a CU-to-DU message including a first EDT indication for one or more UEs. At block 704, in response to the first EDT indication, the DU generates a paging record for each of the one or more UEs and includes a second EDT indication in each of the paging records. The DU 174 then transmits the paging message including the one or more paging records for the UE(s) at block 706. The DU can transmit the paging message on a shared channel (e.g., PDSCH), such that the one or more UEs can receive the paging message.

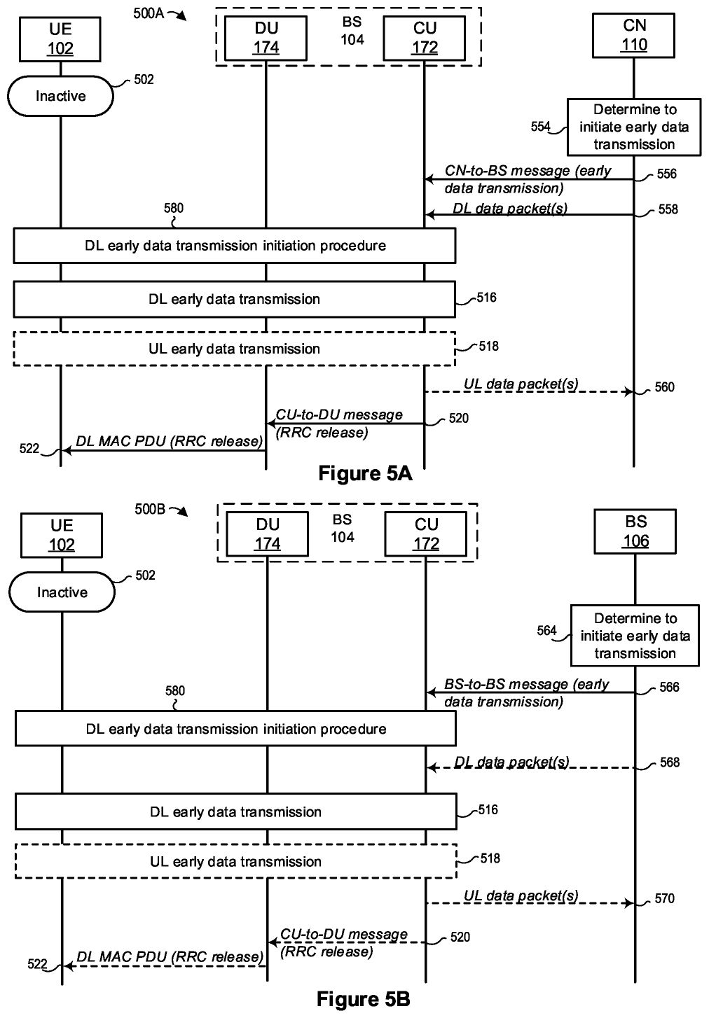

FIG. 8 is a flow diagram of an example method 800 for determining whether to include an EDT indication in a paging message for a UE (e.g., the UE 102), which can be implemented by a DU (e.g., the DU 174). At block 802, the DU 174 receives, from a CU (e.g., the CU 172), a CU-to-DU message indicating that the DU is to page the UE (e.g., events 306A, 480, 580). The DU determines at block 804 whether the CU-to-DU message includes a first EDT indication. If so, then at block 806 the DU transmits a paging message that includes a UE identity of the UE and a second EDT indication for the UE (e.g., events 308-310, 480, 580). In some implementations, the paging message can include a paging record that includes the UE identity and the second EDT indication. If the CU-to-DU message does not include a first EDT indication, then at block 808 the DU transmits a paging message that includes a UE identity of the UE and excludes an EDT indication for the UE. In some implementations, the paging message can include a paging record that includes the UE identity and exclude an EDT indication.

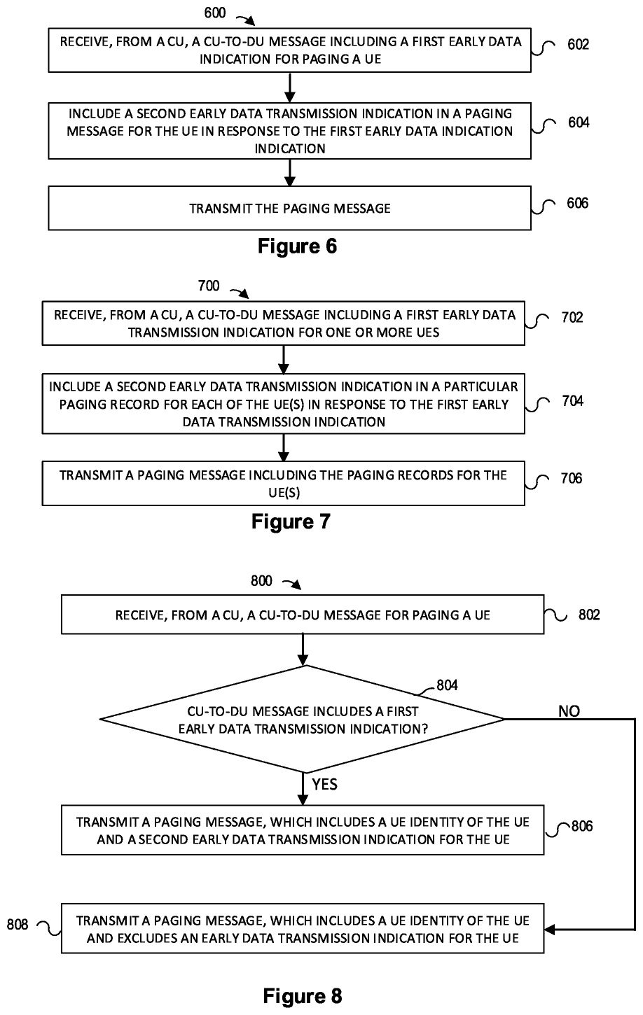

FIG. 9 is a flow diagram of an example method 900 for transmitting a CU-to-DU message to a DU (e.g., the DU 174) that includes an EDT indication, which can be implemented by a CU (e.g., the CU 172). At block 902, the CU determines to initiate EDT to a UE (e.g., the UE 102) (e.g., events 304, 404, 405). In response to the determination, at block 904, the CU includes an EDT indication in a CU-to-DU message, where the CU-to-DU message indicates that the DU should page the DU. At block 906, the CU transmits the CU-to-DU message to the DU in order to cause the DU to page the UE. The CU may include an EDT indication as an element of the CU-to-DU message (e.g., event 306A), or the CU may transmit the EDT indication as an element of a paging message, which the CU can include in the CU-to-DU message (e.g., event 306B).

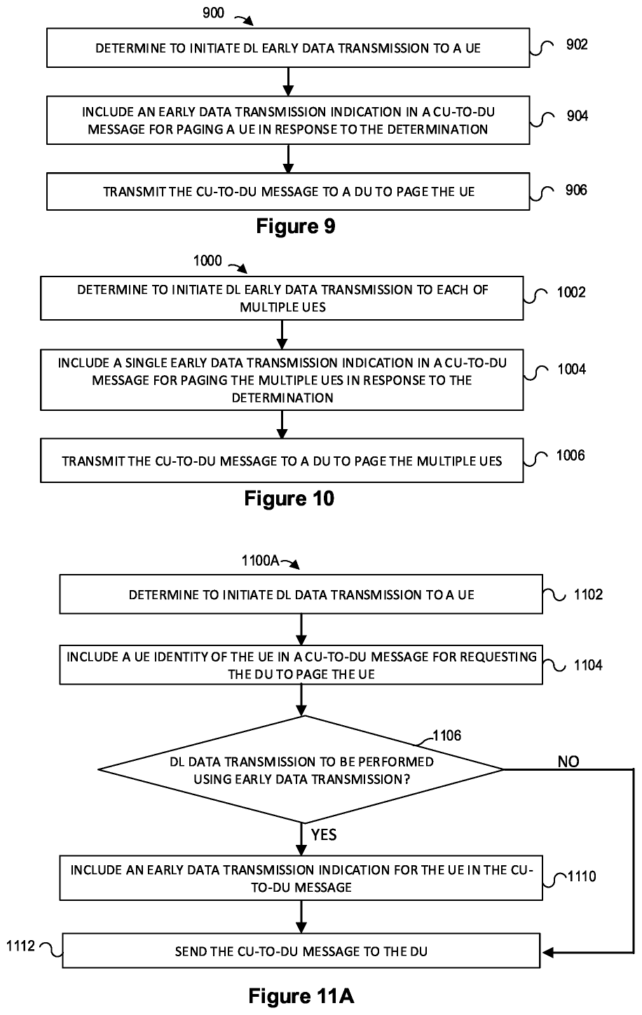

FIG. 10 is a flow diagram of an example method 1000 for transmitting a CU-to-DU message to a DU (e.g., the DU 174) that includes an EDT indication for multiple UEs, which can be implemented by a CU (e.g., the CU 172). At block 1002, the CU determines to initiate DL EDT to each of multiple UEs. In response, at block 1004, the CU includes a single EDT indication in a CU-to-DU message for paging the multiple UEs. Thus, a single EDT indication indicates that multiple UEs are to initiate EDT to receive DL data from the CU 172. At block 1006, the CU transmits the CU-to-DU message to the DU in order to cause the DU to page the multiple UEs.

FIG. 11A is a flow diagram of an example method 1100A for determining whether to include an EDT indication in a CU-to-DU message, which can be implemented by a CU (e.g., the CU 172) or a CU-CP (e.g., the CU-CP 172A). While the description of FIGS. 11A-11D primarily refer to the CU as performing the methods 1100A-1100D, more particularly, these methods may be performed by the CU-CP node of the CU. At block 1102, the CU determines to initiate DL data transmission to a UE (e.g., the UE 102). At block 1104, the CU includes a UE identity of the UE in a CU-to-DU message that the CU is to transmit to a DU (e.g., the DU 174) to cause the DU to page the UE. At block 1106, the CU determines whether the DL data transmission is to be performed using EDT (e.g., events 304, 404, 405). If so, then the CU includes, at block 1110, an EDT indication for the UE in the CU-to-DU message. The CU can include the EDT indication as an element of the CU-to-DU message (e.g., event 306A), or as an element of a paging message that the CU includes in the CU-to-DU message (e.g., event 306B). If the CU determines not to utilize EDT to transmit the DL data, the CU does not include the EDT indication in the CU-to-DU message and proceeds directly from block 1106 to block 1112. At block 1112, the CU sends the CU-to-DU message to the DU (e.g., events 306A, 306B, 480, 580).

FIG. 11B is a flow diagram of an example method 1100B similar to the method of FIG. 11A, but where the CU determines whether to include the EDT indication based on a volume of data to be transmitted to the UE. At block 1101, the CU receives, from a CN, edge server, CU-UP node (if the method 1100B is performed by the CU-CP node), or another base station, data for a UE (e.g., event 403C, 558, 568). At block 1104, the CU includes a UE identity of the UE in a CU-to-DU message that the CU is to transmit to a DU to cause the DU to page the UE. At block 1105, the CU determines whether the volume of the data is below a threshold (e.g., a threshold for EDT) (e.g., event 405). If so, then the CU includes, at block 1110, an EDT indication for the UE in the CU-to-DU message. Otherwise, the CU does not include the EDT indication in the CU-to-DU message and proceeds directly from block 1105 to block 1112. At block 1112, the CU sends the CU-to-DU message to the DU (e.g., events 306A, 306B, 480, 580).

FIG. 11C is a flow diagram of an example method 1100C similar to the method of FIG. 11A, but where the CU determines whether to include the EDT indication based on whether a message that the CU receives indicates to use EDT. At block 1103, the CU receives, from a CN, edge server, CU-UP node (if the method 1100C is performed by the CU-CP node), or another base station, a message indicating that the CU is to transmit DL data to a UE (e.g., event 432, 403D, 556, 566). The message may be a control-plane message. At block 1104, the CU includes a UE identity of the UE in a CU-to-DU message that the CU is to transmit to a DU to cause the DU to page the UE. At block 1107, the CU determines whether the message the CU received at block 1103 indicates that the CU is to use EDT to transmit the DL data to the UE. If so, then the CU includes, at block 1110, an EDT indication for the UE in the CU-to-DU message. Otherwise, the CU does not include the EDT indication in the CU-to-DU message and proceeds directly from block 1107 to block 1112. At block 1112, the CU sends the CU-to-DU message to the DU (e.g., events 306A, 306B, 480, 580).

FIG. 11D is a flow diagram of an example method 1100D similar to the method of FIG. 11C. However, at block 1108, the CU determines whether the message includes a data size (e.g., in a data size information) that is below a threshold (e.g., a threshold for EDT) (e.g., event 433). If so, then the CU includes the EDT indication in the CU-to-DU message at block 1110.

A CU, or a CU-CP, may be capable of performing one or more of the methods 1100A-1100D. For example, the CU (or CU-CP) may determine to include an EDT indication in a CU-to-DU message based on whether any one of the conditions discussed with reference to blocks 1106, 1105, 1107, or 1108 are present.

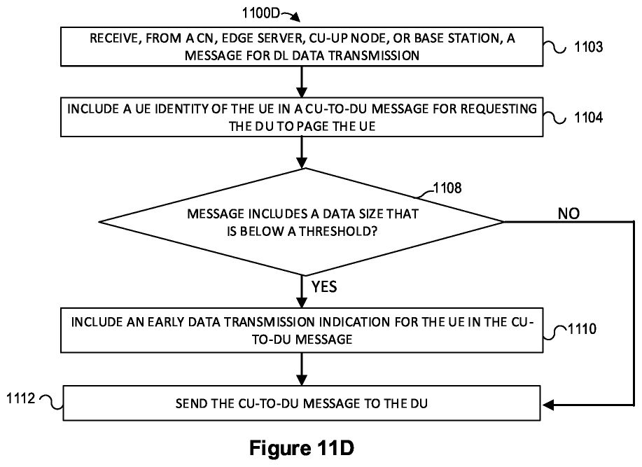

FIG. 12 is a flow diagram of an example method 1200 for transmitting an UP-to-CP message that includes an EDT indication, which can be implemented by a CU-UP (e.g., the CU-UP 172B) of a CU (e.g., the CU 172). At block 1202, the CU-UP determines to initiate DL EDT to a UE (e.g., the UE 102) (e.g., event 404). At block 1204, in response to the determination, the CU-UP includes an EDT indication in an UP-to-CP message for indicating DL data arrival for the UE (e.g., a DL data notification message, such as at event 432). The CU-UP transmits the UP-to-CP message to a CU-CP (e.g., the CU-CP 172A) at block 1206.

FIG. 13A is a flow diagram of an example method 1300A for determining whether to include an EDT indication in an UP-to-CP message, which can be implemented by a CU-UP (e.g., the CU-UP 172B) of a CU (e.g., the CU 172). At block 1302, the CU-UP determines to initiate DL data transmission to a UE (e.g., the UE 102). At block 1304, the CU-UP determines whether the DL data transmission is to be performed using EDT (e.g., event 404). If so, then the CU-UP includes an EDT indication in an UP-to-CP message for indicating DL data arrival for the UE at block 1308, and sends the UP-to-CP message to a CU-CP at block 1312 (e.g., event 432). Otherwise, the CU-UP excludes the EDT indication from the CU-to-CP message at block 1310 and sends the UP-to-CP message to the CU-CP at block 1312.

FIG. 13B is a flow diagram of an example method 1300B similar to the method of FIG. 13A. However, at block 1305, the CU-UP determines whether a volume of data to be transmitted to the UE is below a threshold. If so, then the CU-UP includes the EDT indication in the UP-to-CP that the CU-UP transmits at block 1312.

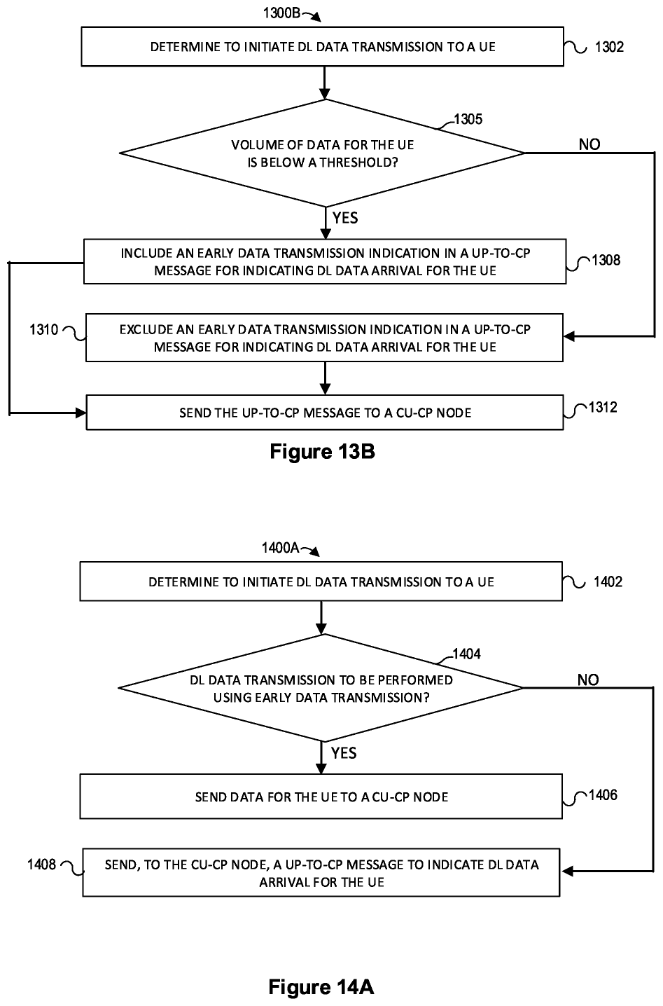

FIG. 14A is a flow diagram of an example method 1400A for determining whether to transmit data for a UE (e.g., the UE 102) to the CU-CP (e.g., the CU-CP 172A), which can be implemented by a CU-UP (e.g., the CU-UP 172B). At block 1402, the CU-UP determines to initiate DL data transmission to a UE. At block 1404, the CU-UP determines whether the DL data is to be transmitted using EDT (e.g., event 404). If so, the CU-UP sends the data for the UE to the CU-CP at block 1406. The CU-CP can then transmit the data to the UE (e.g., event 446). If the CU-UP determines that the DL data is to be transmitted using a different procedure than EDT (e.g., using a legacy RRC resume procedure that causes the UE to transition to the connected state), then the CU-UP sends, to the CU-CP, an UP-to-CP message to indicate DL data arrival for the UE at block 1408. The CU-UP excludes an EDT indication from the UP-to-CP message that the CU-UP sends at block 1408.

FIG. 14B is a flow diagram of an example method 1400B similar to the method of FIG. 14A. However, at block 1405, the CU-UP determines whether a volume of the data for the UE is below a threshold (e.g., a threshold for EDT). If so, then the CU-UP sends the data for the UE to a CU-CP at block 1406.

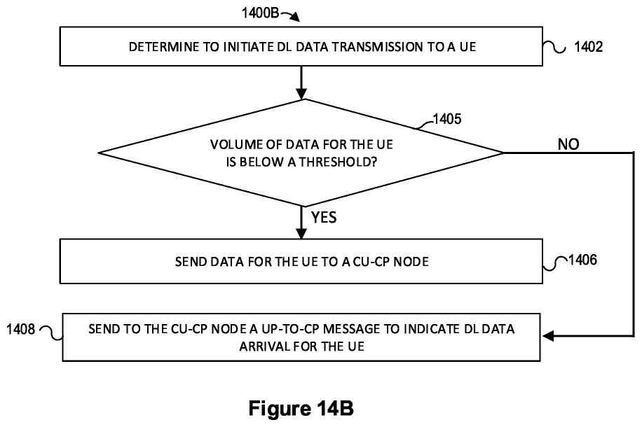

FIG. 15A is a flow diagram of an example method 1500A for determining whether to include an EDT indication in an UP-to-CP message, which can be implemented by a CU-UP (e.g., the CU-UP 172B). At block 1502, the CU-UP receives, from a CN, edge server, CU-CP, or another base station, a message indicating that DL data is available for transmission to a UE (e.g., events 556, 566). At block 1504, the CU-UP determines whether the message includes a first EDT indication. If so, then the CU-UP includes a second EDT indication in an UP-to-CP message at block 1508 and sends the UP-to-CP message to a CU-CP at block 1512. Otherwise, the CU-UP excludes an EDT indication from the UP-to-CP message and sends the UP-to-CP message to the CU-CP at block 1512.

FIG. 15B is a flow diagram of an example method 1500B similar to the method of FIG. 15. However, the CU-UP determines at block 1505 whether to include the EDT indication in the UP-to-CP message based whether the message indicates a data size (e.g., in a data size information) that is below a threshold (e.g., a threshold for EDT). If so, then the CU-UP includes an EDT indication in the UP-to-CP message at block 1508.

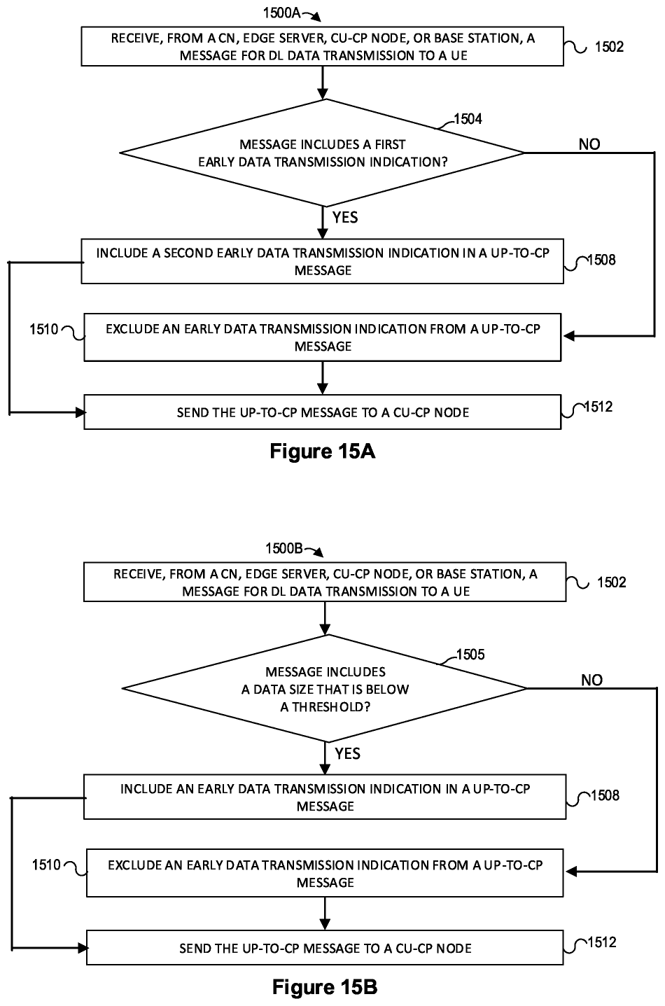

FIG. 16 is a flow diagram of an example method 1600 for managing downlink EDT to a UE when the UE operates in an inactive state associated with a protocol for controlling radio resources (e.g., RRC_IDLE or RRC_INACTIVE), which can be implemented by a CU (e.g., the CU 172) of a distributed base station (e.g., the base station 104). At block 1602, the CU determines to communicate data to the UE without transitioning the UE to a connected state associated with the protocol (e.g., RRC_CONNECTED) (e.g., events 304, 404, 405, or in response to events 556, 558, 566, 568). At block 1604, in response to the determining, the CU transmits, to a DU (e.g., the DU 174) of the distributed base station, an indication that the UE is to initiate a procedure for receiving the data without transitioning to the connected state (e.g., EDT) (e.g., events 306A, 306B, 480, 580).

Transmitting the indication at block 1604 may include transmitting the indication as an element of a CU-to-DU message (e.g., event 306A), or transmitting the indication as an element of a paging message addressed to the UE, the paging message included in a CU-to-DU message (e.g., event 306B).

In some implementations, to make the determination at block 1602, the CU receives the data and performs the determination based on a volume of the data (e.g., based on whether a volume of the data is below a threshold) (e.g., events 404, 403C; methods 1100B, 1300B, 1400B). The CU may receive the data directly from a CN (e.g., event 558) or from a second base station (e.g., event 568). In other implementations, the CU performs the determination at block 1602 based on a message that the CU receives indicating that the data is available for the UE (e.g., from the CN or from a second base station) (e.g., events 403D, 405, 556, 566; methods 1100C, 1100D, 1500A, 1500B). The message may include an indication that the data is to be communicated to the UE without transitioning to the connected state, or may include a size of the data, and the CU can determine whether to use EDT based on the size.

More particularly, the CU may include a control plane node (i.e., a CU-CP) and a user plane node (i.e., a CU-UP). In some implementations, the user plane node performs the determination at block 1602 (e.g., event 404). In response, the user plane node may transmit, to the control plane node, a notification message indicating that (i) the data is available for communication to the UE and (ii) the data is to be communicated to the UE without transitioning the UE to the connected state (e.g., event 432). In response to the notification message, the control plane node transmits the indication to the DU at block 1604 (e.g., event 480). In other implementations, the control plane node performs the determination at block 1602 and transmits the indication at block at block 1604.

At a later time, the CU, or more particularly, the user plane node or the control plane node. may transmit the data to the UE via the DU. For example, the CU can receive a notification from the DU that the UE has initiated the procedure (e.g., event 314), and transmit the data in response to the notification. For example, the control plane node may transmit, to the user plane node, an instruction to transmit the data to the UE via the DU in response to the notification (e.g., event 434). As another example, the user plane node can transmit the data to the control plane node to enable the control plane node to transmit the data to the UE via the DU (e.g., methods 1400A, 1400B).

In some implementations, the CU also determines to communicate second data to a second UE without transitioning the UE to the connected state. In such implementations, the indication further indicates that the second UE is to initiate the procedure for receiving the second data without transitioning to the connected state (e.g., method 1000).

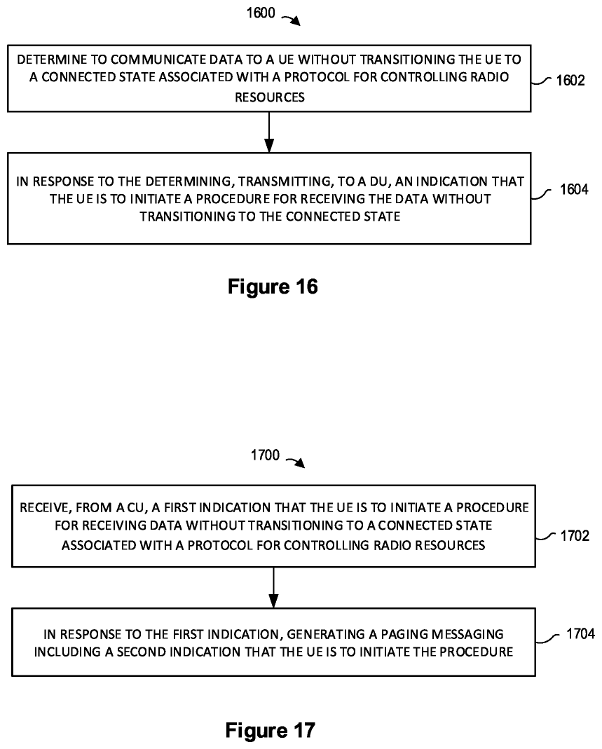

FIG. 17 is a flow diagram of an example method 1700 for managing downlink EDT to a UE when the UE operates in an inactive state associated with a protocol for controlling radio resources (e.g., RRC_IDLE or RRC_INACTIVE), which can be implemented by a DU (e.g., the DU 174) of a distributed base station (e.g., the base station 104). At block 1702, the DU receives, from a CU (e.g., the CU 172) of the distributed base station, a first indication that the UE is to initiate a procedure for receiving data without transitioning to a connected state associated with the protocol (e.g., RRC_CONNECTED) (e.g., event 306A, 480, 580). At block 1704, in response to the first indication, the DU generates a paging message including a second indication that the UE is to initiate the procedure (e.g., event 308, 480, 580).

The DU can transmit the paging message to the UE, e.g., via a shared channel (e.g., event 310). If the DU receives a message from the UE indicating that the UE has initiated the procedure (e.g., event 312), then the DU can transmit the message to the CU (e.g., event 314). The DU also receives the data from the CU and transmits the data to the UE (e.g., event 316). In some implementations, the DU divides the data into data segments and transmits the data segments to the UE in separate MAC PDUs (e.g., event 317). Further, in some implementations, the indication further indicates that a second UE is to initiate the procedure for receiving second data. In such implementations, the DU can generate a first paging record including the second indication, generate a second paging record including a third indication that the second UE is to initiate the procedure, and include the first and second paging records in the paging message (e.g., method 700).

The following list of examples reflects a variety of the embodiments explicitly contemplated by the present disclosure:

Example 1. A method in a central unit (CU) of a distributed base station for managing downlink early data transmission to a user equipment (UE) when the UE operates in an inactive state associated with a protocol for controlling radio resources, the method comprising: determining, by processing hardware of the CU, to communicate data to the UE without transitioning the UE to a connected state associated with the protocol; and in response to the determining, transmitting, by the processing hardware to a distributed unit (DU) of the distributed base station, an indication that the UE is to initiate a procedure for receiving the data without transitioning to the connected state.

Example 2. The method of example 1, wherein transmitting the indication includes: the indication as an element of a CU-to-DU message.

Example 3. The method of example 1, wherein transmitting the indication includes: transmitting the indication as an element of a paging message addressed to the UE, the paging message included in a CU-to-DU message.

Example 4. The method of any one of examples 1-3, further comprising: receiving, by the processing hardware, the data, wherein the determining is based on a volume of the data.

Example 5. The method of example 4, wherein the receiving includes: receiving the data directly from a core network (CN).

Example 6. The method of example 4, wherein the receiving includes: receiving the data from a second base station.

Example 7. The method of any one of examples 1-3, further comprising: receiving, by the processing hardware, a message indicating that the data is available for the UE, wherein the determining is based on the message.

Example 8. The method of example 7, wherein the message further indicates that the data is to be communicated to the UE without transitioning the UE to the connected state.

Example 9. The method of example 7, wherein: the message includes a size of the data; and the determining is based on the size.

Example 10. The method of any one of examples 7-9, wherein the receiving includes: receiving the message directly from a CN.

Example 11. The method of any one of examples 7-9, wherein the receiving includes: receiving the message from a second base station.

Example 12. The method of any one of the preceding examples, wherein: the CU includes a control plane node and a user plane node; and the user plane node determines to communicate the data to the UE without transitioning the UE to the connected state.

Example 13. The method of example 12, further comprising: transmitting, from the user plane node to the control plane node, a notification message indicating that (i) the data is available for communication to the UE and (ii) the data is to be communicated to the UE without transitioning the UE to the connected state, wherein the control plane node transmits the indication to the DU in response to the notification message.

Example 14. The method of example 12 or 13, further comprising: transmitting, from the user plane node to the control plane node, the data; and transmitting, from the control plane node to the UE via the DU, the data.

Example 15. The method of any one of examples 1-11, wherein: the CU includes a control plane node and a user plane node; and the control plane node determines to communicate the data to the UE without transitioning the UE to the connected state; and the control plane node transmits the indication to the DU in response to the determining.

Example 16. The method of example 15, further comprising: receiving, by the processing hardware from the UE via the DU, a notification that the UE has initiated the procedure; and in response to the notification, transmitting, from the control plane node to the UE via the DU, the data.

Example 17. The method of any one of examples 12, 13, or 15, further comprising: receiving, by the processing hardware from the UE via the DU, a notification indicating that the UE has initiated the procedure; and in response to the notification, transmitting, from the control plane node to the user plane node, an instruction to transmit the data to the UE via the DU.

Example 18. The method of any one of the preceding examples, wherein: the UE is a first UE and the data is first data; the determining further includes determining to communicate second data to a second UE without transitioning the second UE to the connected state; and the indication further indicates that the second UE is to initiate the procedure for receiving the second data without transitioning to the connected state.

Example 19. A method in a distributed unit (DU) of a distributed base station for managing downlink early data transmission to a user equipment (UE) when the UE operates in an inactive state associated with a protocol for controlling radio resources, the method comprising: receiving, by processing hardware of the DU from a central unit (CU) of the distributed base station, a first indication that the UE is to initiate a procedure for receiving data without transitioning to a connected state associated with the protocol; and in response to the first indication, generating, by the processing hardware, a paging message including a second indication that the UE is to initiate the procedure.

Example 20. The method of example 19, further comprising: transmitting, by the processing hardware via a shared channel, the paging message to the UE; and receiving, by the processing hardware, a message from the UE indicating that the UE has initiated the procedure; and transmitting, by the processing hardware, the message to the CU.

Example 21. The method of example 20, further comprising: receiving, by the processing hardware, the data from the CU; and transmitting, by the processing hardware, the data to the UE.

Example 22. The method of example 21, wherein transmitting the data to the UE includes: dividing the data into data segments; and transmitting the data segments to the UE in separate respective medium access control (MAC) protocol data units (PDUs).

Example 23. The method of any one of examples 19-22, wherein: the UE is a first UE and the data is first data; the first indication further indicates that a second UE is to initiate the procedure for receiving second data; and generating the paging message includes: generating a first paging record including the second indication; generating a second paging record including a third indication that the second UE is to initiate the procedure; and including the first and the second paging records in the paging message.

Example 24. A network node of a distributed base station including processing hardware and configured to implement a method according to any one of the preceding examples.

The following additional considerations apply to the foregoing discussion.

In some implementations, the paging message can be replaced by a paging record. In other implementations, the paging message can include one or more paging records, where each paging record pages a particular UE. For example, the paging message can include a paging record for the UE 102.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

What is claimed is:

1. A method in a central unit (CU) of a distributed base station for managing downlink early data transmission to a user equipment (UE) when the UE operates in an inactive state associated with a protocol for controlling radio resources, the method comprising:
determining, by processing hardware of the CU, to communicate data to the UE without transitioning the UE to a connected state associated with the protocol;
in response to the determining, transmitting, by the processing hardware to a distributed unit (DU) of the distributed base station, an indication that the UE is to initiate a procedure for receiving the data without transitioning to the connected state;
receiving, by the processing hardware from the UE via the DU, a message formatted in accordance with the protocol indicating that the UE has initiated the procedure; and
transmitting, by the processing hardware to the UE via the DU, the data in response to receiving the message.

2. The method of claim 1, wherein transmitting the indication includes:
the indication as an element of a CU-to-DU message.

3. The method of claim 1, wherein transmitting the indication includes:
transmitting the indication as an element of a paging message addressed to the UE, the paging message included in a CU-to-DU message.

4. The method of any one of claims 1-3, further comprising:
receiving, by the processing hardware from a second base station, the data,
wherein the determining is based on a volume of the data.

5. The method of any one of claims 1-3, wherein the message is a second message, the method further comprising:
receiving, by the processing hardware from a second base station, a first message indicating that the data is available for the UE,
wherein the determining is based on the first message.

6. The method of any one of the preceding claims, wherein:
the CU includes a control plane node and a user plane node; and
the user plane node determines to communicate the data to the UE without transitioning the UE to the connected state.

7. The method of claim 6, further comprising:
transmitting, from the user plane node to the control plane node, a notification message indicating that (i) the data is available for communication to the UE and (ii) the data is to be communicated to the UE without transitioning the UE to the connected state,
wherein the control plane node transmits the indication to the DU in response to the notification message.

8. The method of claim 6 or 7, wherein transmitting the data includes:
transmitting, from the user plane node to the control plane node, the data; and
transmitting, from the control plane node to the UE via the DU, the data.

9. The method of any one of the preceding claims, wherein:
the UE is a first UE and the data is first data;
the determining further includes determining to communicate second data to a second UE without transitioning the second UE to the connected state; and
the indication further indicates that the second UE is to initiate the procedure for receiving the second data without transitioning to the connected state.

10. The method of any one of the preceding claims, wherein the DU receives the message from the UE during a random access procedure, and wherein transmitting the data includes:
transmitting the data after the DU performs the random access procedure with the UE.

11. A method in a distributed unit (DU) of a distributed base station for managing downlink early data transmission to a user equipment (UE) when the UE operates in an inactive state associated with a protocol for controlling radio resources, the method comprising:
receiving, by processing hardware of the DU from a central unit (CU) of the distributed base station, a first indication that the UE is to initiate a procedure for receiving data without transitioning to a connected state associated with the protocol;
in response to the first indication, transmitting, by the processing hardware, a paging message including a second indication that the UE is to initiate the procedure;
receiving, by the processing hardware from the UE, a message formatted in accordance with the protocol indicating that the UE has initiated the procedure;
transmitting, by the processing hardware to the CU, the message;
receiving, by the processing hardware from the CU after transmitting the message, the data; and
transmitting, by the processing hardware to the UE, the data.

12. The method of claim 11, wherein transmitting the data to the UE includes:
dividing the data into data segments; and
transmitting the data segments to the UE in separate respective medium access control (MAC) protocol data units (PDUs).

13. The method of any one of claim 11 or 12, wherein:
the UE is a first UE and the data is first data;
the first indication further indicates that a second UE is to initiate the procedure for receiving second data; and
transmitting the paging message includes:
generating a first paging record including the second indication;
generating a second paging record including a third indication that the second UE is to initiate the procedure; and
including the first and the second paging records in the paging message.

14. The method of any one of claims 11-13, wherein:
receiving the message from the UE includes receiving the message during a random access procedure with the UE, and
transmitting the data to the UE includes transmitting the data after performing the random access procedure with the UE.

15. The method of claim 14, further comprising:
transmitting, by the processing hardware to the UE, a random access response during the random access procedure,
wherein transmitting the data includes transmitting the data after transmitting the random access response.

16. The method of any one of the preceding claims, wherein the message is a Radio Resource Control (RRC) message.

17. A network node of a distributed base station including processing hardware and configured to implement a method according to any one of the preceding claims.
